(19) United States
(12) Patent Application Publication
(10) Pub. No.: US 2026/0253581 A1
(43) Pub. Date: Aug. 27, 2026

(54) SYSTEM

(71) Applicant: SoftBank Group Corp., Tokyo (JP)

(72) Inventor: Tatsuya KAWASAKI, Tokyo (JP)

(73) Assignee: SoftBank Group Corp., Tokyo (JP)

(21) Appl. No.: 19/541,416

(22) Filed: Feb. 17, 2026

(30) Foreign Application Priority Data
Feb. 21, 2025 (JP) 2025-027051

(51) Int. Cl. G10L 15/06

(52) U.S. Cl. CPC G10L 15/063

(57) ABSTRACT

The system according to the embodiment comprises a recording unit, an analysis unit, and a providing unit. The recording unit records conversations. The analysis unit analyzes conversations recorded by the recording unit. The providing unit provides a user with an analysis result obtained by the analysis unit.

### CROSS-REFERENCE TO RELATED APPLICATION

The present application claims priority to and incorporates by reference the entire contents of Japanese Patent Application No. 2025-027051 filed in Japan on Feb. 21, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In conventional technology, daily conversations have not been sufficiently recorded and analyzed for use in dementia prevention, and there is room for improvement.

### SUMMARY OF THE INVENTION

The system according to the embodiment comprises a recording unit, an analysis unit, and a providing unit. The recording unit records conversations. The analysis unit analyzes conversations recorded by the recording unit. The providing unit provides a user with an analysis result obtained by the analysis unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor denoted by a reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) denoted by a reference numeral is a memory where information is temporarily stored and used as a work memory by the processor.

In the following embodiments, a storage denoted by a reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) denoted by a reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

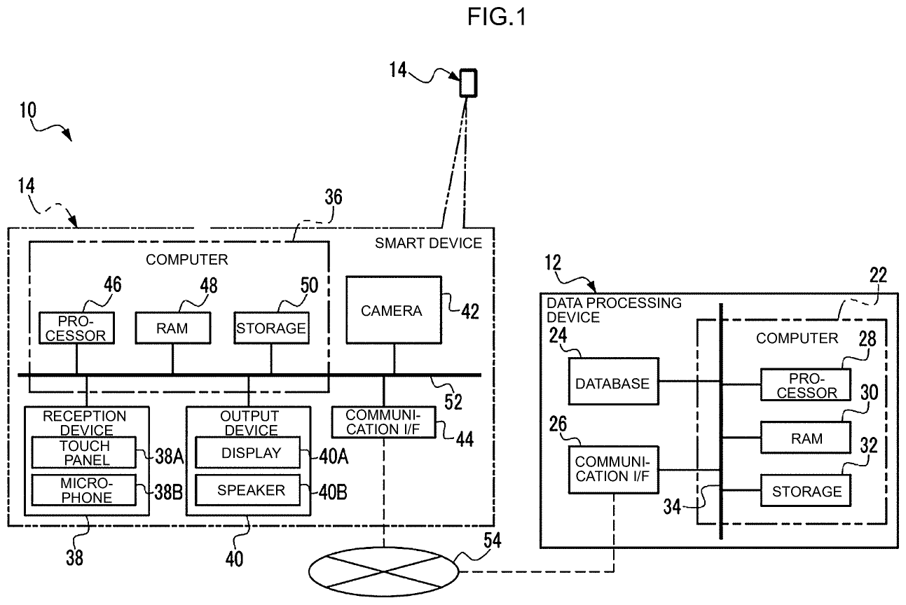

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

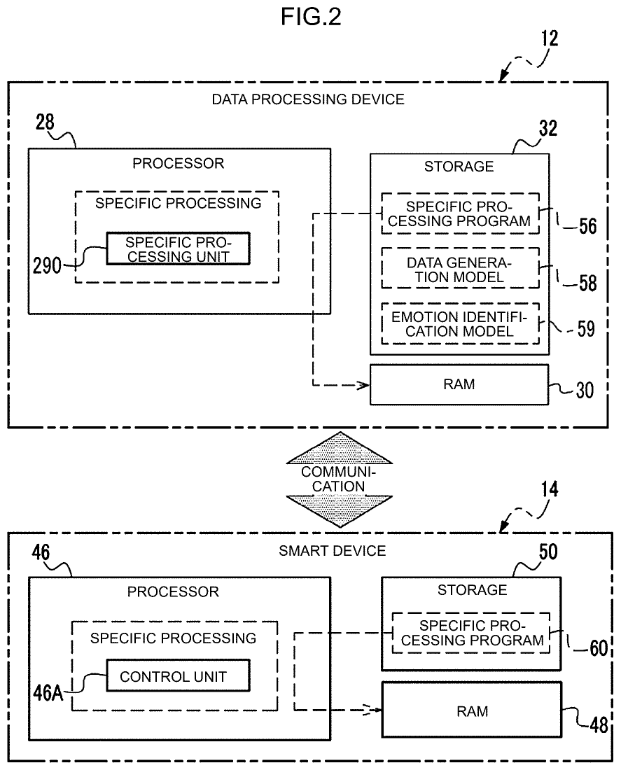

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example of the Embodiment

The dementia prevention system according to the embodiment of the present invention is a system aimed at preventing dementia in an aging society. This dementia prevention system records daily conversations and utilizes these records to promote dementia prevention. First, the system records the user's daily conversations using speech recognition technology. Next, the system analyzes the recorded conversations with AI to extract important content and specific keywords. For example, if there is a statement such as “I don't remember saying that,” the AI searches for that statement in the records and presents it to the user. This allows the user to confirm and become aware of their own statements. Additionally, the system provides topics related to the user's place of origin and past events, prompting the user to recall memories, thereby contributing to dementia prevention. For instance, the AI provides stories about the user's place of origin, and by having the user talk about these topics, it stimulates memory and helps maintain cognitive function. Furthermore, the system periodically provides feedback on analysis results, making it easier for the user to understand the state of their cognitive function. Thus, the dementia prevention system can promote dementia prevention by recording, analyzing, and providing daily conversations of the user. Specifically, this dementia prevention system is composed of multiple hardware and software modules, including a recording unit, an analysis unit, and a providing unit. The recording unit acquires the user's spoken audio using a high-precision microphone array and collects it as 16 kHz/16 bit PCM audio data. The recording unit converts the collected audio data into a spectrogram, extracts acoustic features (e.g., MFCC, zero-crossing rate, pitch, etc.), and inputs them into a speech recognition engine (e.g., a deep neural network-based speech recognition model). The speech recognition model may use an encoder-decoder type recurrent neural network or a Transformer-based model with self-attention mechanisms. Examples of input include a 5-second audio waveform (80,000 samples) or its spectrogram (128 dimensions×100 frames). The output of speech recognition is utterance text (e.g., “It's nice weather today”) and a confidence score for each utterance (e.g., 0.95). The analysis unit inputs the text data obtained from the recording unit into a large-scale language model for natural language processing (e.g., a Transformer-based encoder-decoder model). Examples of input include a day's worth of conversation text (about 1,000 tokens) or a sequence of the most recent 10 utterances. The analysis unit generates word distributed representations (Word2Vec or BERT embeddings) and calculates importance scores from the conversation. For example, when an utterance such as “I don't remember saying that” appears, the analysis unit searches the past utterance history (e.g., a database of utterances from the past week) to determine the presence and frequency of the relevant utterance. The output of the analysis unit includes an important utterance list (utterance text+utterance time+importance score), keyword extraction results (e.g., [‘place of origin’, ‘old stories’, ‘memory’]), and a self-contradiction detection flag for utterances (e.g., True/False). The providing unit receives the output from the analysis unit and displays the analysis results on a user interface (tablet device, smart speaker, etc.) or outputs them via speech synthesis. For example, it may display “There was a similar statement in the past” on the screen or notify by voice “You talked about the same topic last week.” Furthermore, the providing unit generates topics related to the user's place of origin and past events by referring to a user profile database (e.g., place of origin: Hokkaido, hobby: fishing, past events: wedding, etc.) and inputs related topic prompts into a topic generation AI (large-scale language model). Examples of input include “Generate three old stories related to the user's place of origin.” Example outputs are topic sentences such as “Do you remember having snowball fights in winter as a child?” These topics are designed to promote memory recall and activate the brain. The system periodically (e.g., every day at 9 a.m., once a week, etc.) aggregates analysis results, generates cognitive function scores for the user (e.g., time-series graphs of memory, attention, amount of speech, etc.), and provides feedback to the user, family, and medical professionals. As a technical effect, this system enables high-speed processing of large-scale data, self-contradiction detection in utterances, individually optimized topic generation, and quantitative cognitive function evaluation, which are impossible with manual recording, analysis, and topic provision by humans. This allows for highly accurate and real-time detection of early signs of dementia and enables optimal preventive intervention for each user. Application fields include monitoring of elderly people at home, dementia prevention programs in care facilities, remote medical support, and personal health management applications.

The dementia prevention system according to the embodiment comprises a recording unit, an analysis unit, and a providing unit. The recording unit records the user's daily conversations. For example, the recording unit can record conversations using speech recognition technology. The speech recognition technology converts the user's utterances into text data in real time and records them. For example, the recording unit collects the content spoken by the user with a microphone and converts it into text data using speech recognition technology. Alternatively, the recording unit can record the content spoken by the user and later convert it into text data using speech recognition technology. The analysis unit analyzes the conversations recorded by the recording unit. For example, the analysis unit uses AI to analyze the content of the conversation and extract important content and specific keywords. The AI analyzes the content of the conversation using natural language processing technology and extracts important information. For example, the analysis unit extracts frequently occurring keywords and specific topics from the conversation. The analysis unit can also analyze the content of the conversation based on keywords set by the user. The providing unit provides the analysis result obtained by the analysis unit to the user. For example, the providing unit provides the analysis result to the user using screen display or audio output. For example, the providing unit displays the analysis result on the screen so that the user can check it. Alternatively, the providing unit can output the analysis result by voice and provide it to the user. Thus, the dementia prevention system according to the embodiment can promote dementia prevention by recording, analyzing, and providing the user's daily conversations. Specifically, this dementia prevention system uses a high-precision microphone array as the recording unit to acquire the user's spoken audio as 16 kHz/16 bit PCM audio data. The recording unit converts the acquired audio data into a spectrogram and extracts acoustic features such as MFCC, zero-crossing rate, and pitch. The recording unit inputs these features into a deep neural network-based speech recognition model (e.g., encoder-decoder type recurrent neural network or Transformer-based model with self-attention mechanism). Examples of input include a 5-second audio waveform (80,000 samples) or a spectrogram of 128 dimensions×100 frames. The speech recognition model outputs utterance text (e.g., “It's nice weather today”) and a confidence score for each utterance (e.g., 0.95). The analysis unit inputs the text data obtained from the recording unit into a large-scale language model for natural language processing (e.g., Transformer-based encoder-decoder model). Examples of input include a day's worth of conversation text (about 1,000 tokens) or a sequence of the most recent 10 utterances. The analysis unit generates word distributed representations (Word2Vec or BERT embeddings) and calculates importance scores from the conversation. For example, when an utterance such as “I don't remember saying that” appears, the analysis unit searches the utterance database for the past week to determine the presence and frequency of the relevant utterance. The output of the analysis unit includes an important utterance list (utterance text+utterance time+importance score), keyword extraction results (e.g., [‘place of origin’, ‘old stories’, ‘memory’]), and a self-contradiction detection flag (True/False). The providing unit receives the output from the analysis unit and displays the analysis results on a user interface (tablet device or smart speaker, etc.) or outputs them via speech synthesis. For example, it may display “There was a similar statement in the past” on the screen or notify by voice “You talked about the same topic last week.” Furthermore, the providing unit refers to a user profile database (place of origin, hobby, past events, etc.), inputs related topic prompts into a topic generation AI (large-scale language model), and gives instructions such as “Generate three old stories related to the user's place of origin.” Example outputs are topic sentences such as “Do you remember having snowball fights in winter as a child?” These topics are designed to promote memory recall and activate the brain. The system periodically aggregates analysis results, generates cognitive function scores for the user (e.g., time-series graphs of memory, attention, amount of speech, etc.), and provides feedback to the user, family, and medical professionals. As a technical effect, this system enables high-speed processing of large-scale data, self-contradiction detection in utterances, individually optimized topic generation, and quantitative cognitive function evaluation, which are impossible with manual recording, analysis, and topic provision by humans. This allows for highly accurate and real-time detection of early signs of dementia and enables optimal preventive intervention for each user. Application fields include monitoring of elderly people at home, dementia prevention programs in care facilities, remote medical support, and personal health management applications.

The analysis unit can extract important content and specific keywords. For example, the analysis unit uses AI to analyze the content of the conversation and extract important content and specific keywords. The AI analyzes the content of the conversation using natural language processing technology and extracts important information. For example, the analysis unit extracts frequently occurring keywords and specific topics from the conversation. The analysis unit can also analyze the content of the conversation based on keywords set by the user. By extracting important content and specific keywords, necessary information can be provided to the user. Specifically, the analysis unit inputs utterance text data received from the recording unit (e.g., a day's worth of conversation text, 1,000 tokens, or a sequence of the most recent 10 utterances) into a large-scale language model for natural language processing (e.g., Transformer-based encoder-decoder model). The analysis unit first tokenizes the input text and vectorizes each word or phrase (e.g., BERT embedding, 768 dimensions). Next, the analysis unit uses a self-attention mechanism to extract contextual information and calculates an importance score for each utterance (e.g., a continuous value from 0.0 to 1.0). For example, the utterance “It's nice weather today” may be judged as importance 0.2, while “I don't remember saying that” may be judged as importance 0.9. Furthermore, the analysis unit extracts frequently occurring keywords (e.g., [‘place of origin’, ‘memory’, ‘old stories’]) and topic distributions (e.g., topic clustering by LDA) using TF-IDF or attention weights. If keywords set by the user (e.g., [‘family’, ‘health’]) appear in the conversation, the analysis unit extracts the relevant utterance and outputs it as structured data along with the utterance time and speaker information. Examples of input to the AI include text sequences such as “Yesterday's conversation: It's nice weather today. I don't remember saying that. We talked about the same topic last week.” Example outputs include an important utterance list (utterance text+time+importance score), keyword extraction results ([‘memory’, ‘old stories’]), and a self-contradiction detection flag (True/False). The analysis unit sends these outputs to the providing unit, which uses them as basic data for feedback to the user and topic generation. As a technical effect, the analysis unit enables high-speed analysis of large-scale conversation data, automatic detection of self-contradictions and important utterances, and optimized keyword extraction for each user, which are difficult to achieve manually. This allows for highly accurate and real-time detection of early signs of dementia and enables optimal preventive intervention for each user. Application fields include monitoring of elderly people at home, dementia prevention programs in care facilities, remote medical support, and personal health management applications.

The providing unit may comprise a topic providing unit configured to provide topics related to the user's place of origin and past events. For example, the providing unit comprises a topic providing unit configured to provide topics related to the user's place of origin and past events. The topic providing unit, for example, provides old stories related to the user's place of origin. For instance, the topic providing unit collects information about the user's place of origin and provides topics based on that information. The topic providing unit can also provide topics related to the user's past events. For example, the topic providing unit collects information about the user's past events and provides topics based on that information. By providing topics related to the user's place of origin and past events, memory can be stimulated and dementia prevention can be promoted. Specifically, the providing unit refers to a user profile database (e.g., place of origin: Hokkaido, hobby: fishing, past events: wedding, etc.) and extracts attribute information of the user. The topic providing unit inputs the extracted attribute information as a prompt into a large-scale language model and generates instruction sentences such as “Generate three old stories related to the user's place of origin” or “Generate topics related to events the user has experienced.” Examples of input to the AI include structured data such as “place of origin: Hokkaido, past events: wedding, hobby: fishing” or prompts such as “Generate old stories related to the user's place of origin.” Example outputs from the AI include topic sentences such as “Do you remember having snowball fights in winter as a child?” or “What memorable events do you recall from your wedding?” The topic providing unit displays the generated topic sentences on a user interface (tablet device or smart speaker, etc.) or outputs them via speech synthesis. Furthermore, the topic providing unit can analyze the user's past conversation history and areas of interest to individually optimize the content and expression of topics. For example, if there have been many conversations about “fishing” in the past, topics related to fishing are preferentially generated. As a technical effect, the topic providing unit enables individually optimized topic generation, dynamic topic provision based on user attributes, and diverse topic generation to promote memory recall, which are difficult to achieve manually. This allows for activation of the user's brain and maintenance or improvement of cognitive function. Application fields include conversation support for elderly people at home, recreation in care facilities, remote medical support, and personal health management applications.

The providing unit may comprise a feedback unit configured to periodically provide feedback of the analysis result. For example, the providing unit comprises a feedback unit configured to periodically provide feedback of the analysis result. The feedback unit, for example, provides feedback of the analysis result to the user at regular intervals such as daily, weekly, or monthly. For instance, the feedback unit provides the daily analysis result to the user so that the user can understand the state of their cognitive function. The feedback unit can also provide the weekly analysis result to the user so that the user can check changes in their cognitive function. By periodically providing feedback of the analysis result, it becomes easier for the user to understand the state of their cognitive function. Specifically, the feedback unit aggregates and formats analysis results such as cognitive function scores (e.g., memory, attention, amount of speech as time-series data), important utterance lists, and keyword extraction results received from the analysis unit according to a predetermined schedule (e.g., every day at 9 a.m., once a week, once a month, etc.), and provides feedback to the user, family, and medical professionals. The feedback unit automatically generates time-series graphs (e.g., transition graph of amount of speech, time-series chart of memory score) and summary reports of analysis results (e.g., “Memory score is trending upward this week”). Examples of input to the AI include an array of cognitive function scores for the past week (e.g., a list of dates and score values), important utterance lists (e.g., utterance text+time+importance). Example outputs from the AI include summary sentences such as “This week's memory score is up 5% compared to last week” or “Two self-contradictory utterances were detected in the past seven days,” as well as graph image data. The feedback unit displays this feedback information on the user interface or notifies via speech synthesis. Furthermore, the feedback unit can dynamically adjust the content and expression of feedback according to the user's emotion and living situation. As a technical effect, the feedback unit enables quantitative and periodic aggregation of large-scale data, visualization of time-series changes in cognitive function, and individually optimized feedback provision, which are difficult to achieve manually. This allows the user to easily understand the state and changes of their cognitive function and leads to early preventive intervention and medical consultation. Application fields include health management for elderly people at home, dementia prevention programs in care facilities, remote medical support, and personal health management applications.

The recording unit can estimate a user's emotion and adjust a timing for recording a conversation based on the estimated emotion of the user. For example, the recording unit estimates the user's emotion and adjusts the timing for recording a conversation based on the estimated emotion. Emotion estimation is realized by using an emotion engine or generative AI, among other emotion estimation functions. Generative AI may include text generation AI (e.g., LLM) or multimodal generative AI, but is not limited to these examples. For instance, when the user is relaxed, the recording unit sets a lower recording frequency to prioritize natural conversation. When the user is excited, the recording unit sets a higher recording frequency to avoid missing important utterances. When the user is stressed, the recording unit may temporarily pause recording and wait until the user calms down. By adjusting the timing for recording a conversation according to the user's emotion, important utterances can be captured while prioritizing natural conversation. Specifically, the recording unit acquires the user's spoken audio data (e.g., 16 kHz/16 bit PCM audio waveform, 80,000 samples for 5 seconds) using a high-precision microphone array, performs spectrogram conversion (128 dimensions×100 frames) and MFCC extraction, and generates acoustic features. The recording unit inputs these acoustic features into an emotion estimation convolutional neural network (CNN), recurrent neural network (RNN), or Transformer-based multimodal model. Examples of input to the AI include audio spectrogram (128×100), utterance text (“It's nice weather today”), and facial image (224×224 pixels). The recording unit outputs emotion labels (e.g., relaxed, excited, stressed), emotion scores (e.g., relaxed 0.8, excited 0.1, stressed 0.1), and time-series data of emotion changes from these inputs. For example, the recording unit can estimate emotion transitions such as “relaxed →excited →stressed” for consecutive utterances. Based on the emotion estimation results, the recording unit automatically sets recording frequency parameters (e.g., every 1 minute, every 5 minutes, every 10 minutes) and recording pause flags (True/False). In subsequent processing, when the emotion is judged as “excited” or “stressed,” the recording unit switches to real-time recording mode to increase recording frequency and prevent missing important utterances. When the emotion is judged as “relaxed,” the recording unit reduces recording frequency to avoid interfering with the user's natural conversation experience. Furthermore, when the emotion “stressed” exceeds a threshold, the recording unit pauses recording to reduce the user's psychological burden. The recording unit notifies the analysis unit and providing unit of these control parameters to coordinate overall system behavior. As a technical effect, the recording unit enables real-time emotion estimation and optimal recording timing, which are difficult to achieve by human subjective judgment or manual operation, thereby improving the quality of recorded data, comprehensively capturing important utterances, and enhancing user experience. Application fields include monitoring conversations of elderly people at home, psychological care support in care facilities, remote medical monitoring, and personal health management applications.

The recording unit can analyze a user's past conversation history and select an appropriate recording method. For example, the recording unit analyzes a user's past conversation history and selects an appropriate recording method. The recording unit may preferentially record topics that the user has frequently discussed in the past. The recording unit can also analyze the user's conversation patterns and set the most effective recording timing. Furthermore, the recording unit may preferentially record conversations containing important keywords extracted from the user's past conversation history. By analyzing the user's past conversation history, the optimal recording method can be selected and important conversations can be preferentially recorded. Specifically, the recording unit acquires conversation text data for the past week to month (e.g., 1,000 tokens per day×7 days=7,000 tokens) from a database and inputs it into a large-scale language model for natural language processing (e.g., Transformer-based encoder-decoder model). The recording unit tokenizes the input text and generates word distributed representations (BERT embedding, 768 dimensions). The recording unit extracts topic distributions of conversations (e.g., topic clustering by LDA), a list of frequently occurring keywords (top 10 by TF-IDF score), and conversation patterns (e.g., time-series patterns such as morning greetings, nighttime health topics). Examples of input to the AI include “conversation text sequence for the past 7 days” and “list of past utterance times and contents.” Example outputs from the AI include “frequent topics: health, family, hobbies,” “important keywords: memory, exercise, diet,” and “recommended recording timing: 7-8 a.m., 8-9 p.m.” The recording unit automatically generates recording priority parameters (e.g., priority score for each topic), recording timing schedules (e.g., increased recording frequency during specific time periods), and keyword filtering rules based on these outputs. In subsequent processing, the recording unit dynamically controls the recording frequency for new conversation data acquired in real time, increasing recording frequency when important topics or keywords extracted from past history appear, or switching recording modes when specific conversation patterns are detected. As a technical effect, the recording unit enables automatic analysis of large-scale history data and optimization of recording strategies, which are difficult to achieve by human experience or manual work, thereby comprehensively capturing important conversations, improving recording efficiency, and enabling individual optimization for each user. Application fields include monitoring conversations of elderly people at home, improving recording efficiency in care facilities, remote medical support, and personal health management applications.

The recording unit can perform filtering based on the user's current living situation and areas of interest when recording a conversation. For example, the recording unit performs filtering based on the user's current living situation and areas of interest when recording a conversation. The recording unit may preferentially record conversations related to topics the user is currently interested in. The recording unit can also select and record important conversations according to the user's living situation. Furthermore, the recording unit may filter and record highly relevant conversations based on the user's areas of interest. By filtering conversations based on the user's current living situation and areas of interest, highly relevant conversations can be preferentially recorded. Specifically, the recording unit refers to a user profile database (e.g., living situation=at home, areas of interest=gardening, health, travel) and recent activity history (e.g., activity logs from a smartwatch, calendar schedule) to generate filtering conditions. The recording unit inputs real-time acquired conversation text (e.g., about 100 tokens per utterance) into a large-scale language model for natural language processing, and calculates topic classification for each utterance (e.g., gardening, health, travel, family, etc.) and interest score (0.0-1.0). Examples of input to the AI include “utterance text+user areas of interest list” and “utterance text+living situation tag.” Example outputs from the AI include “utterance topic: gardening, interest score 0.9” and “utterance topic: health, interest score 0.7.” The recording unit preferentially records utterances with an interest score above a predetermined threshold (e.g., 0.7), while reducing the recording frequency or excluding other utterances from recording. In subsequent processing, the recording unit notifies the analysis unit of the filtering results, which are used as basic data for detailed analysis and topic generation in the analysis unit. As a technical effect, the recording unit enables real-time filtering of areas of interest and optimal recording, which are difficult to achieve by human subjective judgment or manual work, thereby improving the relevance of recorded data, reducing unnecessary data, and enhancing user experience. Application fields include monitoring conversations of elderly people at home, individual care support in care facilities, remote medical monitoring, and personal health management applications.

The recording unit can estimate a user's emotion and determine a priority of conversations to be recorded based on the estimated emotion of the user. For example, the recording unit estimates the user's emotion and determines a priority of conversations to be recorded based on the estimated emotion. Emotion estimation is realized by using an emotion engine or generative AI, among other emotion estimation functions. Generative AI may include text generation AI (e.g., LLM) or multimodal generative AI, but is not limited to these examples. For instance, when the user is relaxed, the recording unit preferentially records daily conversations. When the user is excited, the recording unit may preferentially record important utterances. When the user is stressed, the recording unit may preferentially record emotional conversations. By determining the priority of conversations to be recorded according to the user's emotion, important conversations can be preferentially recorded. Specifically, the recording unit acquires the user's spoken audio data (e.g., 16 kHz/16 bit PCM audio waveform, 80,000 samples for 5 seconds) and utterance text using a high-precision microphone array and speech recognition engine, and extracts acoustic features (MFCC, pitch, zero-crossing rate, etc.) and text features (BERT embedding, etc.). The recording unit inputs these features into an emotion estimation deep neural network (e.g., CNN+RNN hybrid model or Transformer-based multimodal model). Examples of input to the AI include audio spectrogram (128×100), utterance text (“It's nice weather today”), and facial image (224×224 pixels). Example outputs from the AI include emotion labels (relaxed, excited, stressed), emotion scores (relaxed 0.7, excited 0.2, stressed 0.1), and emotion change flags for each utterance. The recording unit assigns a recording priority score (0.0-1.0) to each utterance based on the emotion estimation results and preferentially records utterances with high priority (e.g., important utterances during excitement, emotional utterances during stress). In subsequent processing, the recording unit selects utterances to be recorded, dynamically adjusts recording frequency, and assigns priority flags to utterances for the analysis unit based on the priority score. As a technical effect, the recording unit enables real-time emotion estimation and optimal recording priority, which are difficult to achieve by human subjective judgment or manual work, thereby comprehensively capturing important conversations, improving recording efficiency, and enhancing user experience. Application fields include monitoring conversations of elderly people at home, psychological care support in care facilities, remote medical monitoring, and personal health management applications.

The recording unit can preferentially record highly relevant conversations by considering the user's geographic location information when recording a conversation. For example, the recording unit preferentially records highly relevant conversations by considering the user's geographic location information when recording a conversation. For instance, when the user is in a specific location, the recording unit preferentially records conversations related to that location. When the user is traveling, the recording unit may preferentially record conversations related to the travel destination. When the user is at home, the recording unit may preferentially record conversations within the household. By considering the user's geographic location information, highly relevant conversations can be preferentially recorded. Specifically, the recording unit acquires the user's current location information (e.g., latitude and longitude, facility name, room number, etc.) in real time from GPS sensors or Wi-Fi/Bluetooth beacons and links it with conversation recording data. The recording unit inputs conversation text (e.g., about 100 tokens per utterance) into a large-scale language model for natural language processing and calculates a relevance score (0.0-1.0) between the utterance content and geographic location information. Examples of input to the AI include “utterance text+current location: home” and “utterance text+current location: travel destination (Kyoto).” Example outputs from the AI include “relevance score: 0.9 (travel destination related)” and “relevance score: 0.8 (household related).” The recording unit preferentially records utterances with a relevance score above a predetermined threshold (e.g., 0.7), while reducing the recording frequency or excluding other utterances from recording. In subsequent processing, the recording unit sends location-tagged recording data to the analysis unit, which is used for location-dependent topic generation and feedback. As a technical effect, the recording unit enables real-time location information linkage and optimal recording, which are difficult to achieve by human subjective judgment or manual work, thereby improving the relevance of recorded data, reducing unnecessary data, and enhancing user experience. Application fields include monitoring the lives of elderly people at home, behavior recording in care facilities, health management during travel, and personal life log applications.

The recording unit can analyze a user's social media activity and record relevant conversations when recording a conversation. For example, the recording unit analyzes a user's social media activity and records relevant conversations when recording a conversation. The recording unit may preferentially record conversations related to topics the user is discussing on social media. The recording unit can also analyze the user's social media posts and record highly relevant conversations. Furthermore, the recording unit may preferentially record conversations with the user's social media friends. By analyzing the user's social media activity, highly relevant conversations can be recorded. Specifically, the recording unit periodically acquires the latest post data, comment history, friend list, trending words, and other structured data from multiple social media platforms used by the user (e.g., text-based SNS, image sharing services, microblogging services) via APIs. The recording unit inputs the acquired post data (e.g., up to 500 tokens of text per post, post time, post category, friend tags, etc.) into a large-scale language model for natural language processing (e.g., Transformer-based encoder-decoder model), and performs topic classification of post content (e.g., health, hobbies, family, travel, etc.), keyword extraction (TF-IDF or attention weighting), and friend network analysis (e.g., clustering by graph neural networks). Examples of input to the AI include “post text for the past week+friend list” and “latest trending words+conversation text.” Example outputs from the AI include “priority recording topics: health, travel,” “related friends: Mr. A, Mr. B,” and “post keywords: exercise, memories.” The recording unit calculates a relevance score (0.0-1.0) between real-time acquired conversation text (e.g., about 100 tokens per utterance) and topics/keywords derived from social media, and preferentially records utterances with a relevance score above a predetermined threshold (e.g., 0.7). Furthermore, when a conversation with a friend is detected, the recording unit links the friend ID and conversation content for recording, which is used as basic data for detailed analysis and topic generation in the subsequent analysis unit. In subsequent processing, the recording unit sends highly relevant conversation data to the analysis unit, which is used as basic data for visualizing changes in the user's interests and social activity over time. As a technical effect, the recording unit enables automatic analysis of large-scale social media data and optimization of conversation recording, which are difficult to achieve by human subjective judgment or manual work, thereby comprehensively capturing important conversations related to the user's social interests and network activity, improving recording efficiency, and enabling individual optimization for each user. Application fields include support for preventing social isolation of elderly people at home, programs to promote interaction in care facilities, remote medical support, and personal health management and life log applications.

The analysis unit can estimate a user's emotion and adjust a method of expressing analysis based on the estimated emotion of the user. For example, the analysis unit estimates the user's emotion and adjusts a method of expressing analysis based on the estimated emotion. Emotion estimation is realized by using an emotion engine or generative AI, among other emotion estimation functions. Generative AI may include text generation AI (e.g., LLM) or multimodal generative AI, but is not limited to these examples. For instance, when the user is relaxed, the analysis unit provides detailed analysis results. When the user is excited, the analysis unit may provide concise analysis results. When the user is stressed, the analysis unit may provide visually easy-to-understand analysis results. By adjusting the method of expressing analysis according to the user's emotion, analysis results that are easy for the user to understand can be provided. Specifically, the analysis unit inputs utterance text data received from the recording unit (e.g., a day's worth of conversation text, 1,000 tokens, or a sequence of the most recent 10 utterances), as well as the user's audio features (e.g., MFCC, pitch, spectrogram) and facial images (224×224 pixels), into a multimodal emotion estimation model (e.g., Transformer-based+CNN/RNN hybrid model). Examples of input to the AI include “utterance text+audio spectrogram+facial image” and “conversation history+biometric sensor data.” Example outputs from the AI include “emotion label: relaxed, excited, stressed” and “emotion score: relaxed 0.8, excited 0.1, stressed 0.1.” The analysis unit dynamically switches the method of expressing analysis results (level of detail, degree of summarization, visualization format, etc.) according to the estimated emotion label and score. For example, when relaxed, the analysis unit generates a detailed text analysis report (e.g., importance score for each utterance, keyword list, time-series graph, etc.); when excited, it generates a concise summary sentence extracting only the main points (e.g., “There are three important utterances today”); and when stressed, it generates analysis results emphasizing visual elements such as graphs and icons (e.g., emotion change chart, color-coded keyword map, etc.). In subsequent processing, the analysis unit sends the generated analysis results to the providing unit and optimizes the display format and notification method on the user interface. As a technical effect, the analysis unit enables real-time emotion estimation and automatic optimization of analysis result expression, which are difficult to achieve by human subjective judgment or manual work, thereby providing information tailored to the user's psychological state, improving understanding, reducing stress, and enhancing user experience. Application fields include conversation analysis support for elderly people at home, psychological care in care facilities, remote medical monitoring, and personal health management applications.

The analysis unit can adjust a level of detail of analysis based on the importance of the conversation during analysis. For example, the analysis unit adjusts a level of detail of analysis based on the importance of the conversation during analysis. The analysis unit may perform detailed analysis for important conversations. The analysis unit can also perform concise analysis for daily conversations. Furthermore, the analysis unit may perform detailed analysis of emotional changes for emotional conversations. By adjusting the level of detail of analysis based on the importance of the conversation, detailed analysis can be performed for important conversations. Specifically, the analysis unit inputs conversation text data received from the recording unit (e.g., a day's worth of conversation, 1,000 tokens, or a sequence of the most recent 10 utterances) into a large-scale language model for natural language processing (Transformer-based encoder-decoder model) and calculates an importance score (0.0-1.0) for each utterance. Examples of input to the AI include “conversation text+list of past important utterances” and “utterance text+user-set keywords.” Example outputs from the AI include “importance score for each utterance” and “important utterance list (utterance text+time+importance).” For utterances with a high importance score (e.g., 0.8 or higher), the analysis unit performs detailed content analysis using TF-IDF, attention weights, topic clustering (LDA, etc.), time-series analysis of emotional changes, and self-contradiction detection, and generates a detailed analysis report. For daily conversations with a low importance score, the analysis unit generates only a concise summary of main points or a keyword list. When emotional conversations are detected, the analysis unit includes emotion change graphs and time-series transitions of emotion labels in the analysis results using an emotion estimation model. In subsequent processing, the analysis unit sends analysis results according to the level of detail to the providing unit, enabling users and medical professionals to efficiently grasp information. As a technical effect, the analysis unit enables automatic importance judgment of large-scale conversation data and optimal allocation of analysis resources, which are difficult to achieve by human subjective judgment or manual work, thereby enabling in-depth analysis of important conversations, reducing processing load for unnecessary data, and improving analysis efficiency. Application fields include conversation analysis support for elderly people at home, dementia prevention programs in care facilities, remote medical monitoring, and personal health management applications.

The analysis unit can apply different analysis algorithms according to a category of the conversation during analysis. For example, the analysis unit applies different analysis algorithms according to a category of the conversation during analysis. The analysis unit may apply analysis algorithms specialized for household topics to household conversations. The analysis unit can also apply business-related analysis algorithms to work-related conversations. Furthermore, the analysis unit may apply emotion analysis algorithms to emotional conversations. By applying different analysis algorithms according to the category of the conversation, more appropriate analysis results can be provided. Specifically, the analysis unit inputs conversation text data received from the recording unit (e.g., about 100 tokens per utterance) into a large-scale language model for natural language processing, and first assigns category labels such as “household,” “business,” or “emotional” using a topic classification model (e.g., BERT-based multi-class classifier). Examples of input to the AI include “utterance text+list of category candidates” and “conversation text+past category distribution.” Example outputs from the AI include “category label: household,” “category label: business,” and “category label: emotional.” According to the category label, the analysis unit applies rule-based analysis specialized for household conversations (e.g., extraction of family member names, detection of household events), business term dictionaries and project progress analysis algorithms for business conversations, and emotion estimation models (CNN+RNN hybrid or Transformer-based) for emotion change analysis in emotional conversations. Furthermore, the analysis unit extracts different features for each category (e.g., relationship graphs for household conversations, task progress vectors for business conversations, time-series emotion scores for emotional conversations) and outputs the analysis results as structured data. In subsequent processing, the analysis unit sends category-specific analysis results to the providing unit, enabling users and medical professionals to efficiently grasp information according to the situation. As a technical effect, the analysis unit enables automatic selection of algorithms and optimal analysis for each conversation category, which are difficult to achieve by human subjective judgment or manual work, thereby improving analysis accuracy, reducing processing load for unnecessary data, and enhancing user experience. Application fields include conversation analysis support for elderly people at home, diverse conversation management in care facilities, remote medical monitoring, and personal health management applications.

The analysis unit can estimate a user's emotion and adjust a length of analysis based on the estimated emotion of the user. For example, the analysis unit estimates the user's emotion and adjusts a length of analysis based on the estimated emotion. Emotion estimation is realized by using an emotion engine or generative AI, among other emotion estimation functions. Generative AI may include text generation AI (e.g., LLM) or multimodal generative AI, but is not limited to these examples. For instance, when the user is relaxed, the analysis unit performs detailed analysis and provides longer analysis results. When the user is excited, the analysis unit may perform concise analysis and provide shorter analysis results. When the user is stressed, the analysis unit may provide visually easy-to-understand short analysis results. By adjusting the length of analysis according to the user's emotion, analysis results of appropriate length can be provided to the user. Specifically, the analysis unit inputs utterance text data, audio features, facial images, etc. received from the recording unit into a multimodal emotion estimation model (Transformer+CNN/RNN hybrid) and estimates emotion labels (relaxed, excited, stressed) and emotion scores (e.g., relaxed 0.7, excited 0.2, stressed 0.1). Examples of input to the AI include “utterance text+audio spectrogram” and “conversation history+facial image.” Example outputs from the AI include “emotion label: relaxed” and “emotion score: relaxed 0.7.” According to the emotion label and score, the analysis unit dynamically adjusts the length (level of detail, degree of summarization) of the analysis results. For example, when relaxed, the analysis unit generates a detailed analysis report (e.g., importance score for each utterance, keyword list, time-series graph, etc.); when excited, it generates a short summary sentence extracting only the main points (e.g., “There are three important utterances today”); and when stressed, it generates short analysis results emphasizing visual elements such as graphs and icons (e.g., emotion change chart, color-coded keyword map, etc.). In subsequent processing, the analysis unit sends analysis results according to the length to the providing unit, enabling information presentation tailored to the user's psychological state. As a technical effect, the analysis unit enables real-time emotion estimation and automatic optimization of analysis result length, which are difficult to achieve by human subjective judgment or manual work, thereby improving user understanding, reducing stress, and enhancing user experience. Application fields include conversation analysis support for elderly people at home, psychological care in care facilities, remote medical monitoring, and personal health management applications.

The analysis unit can determine a priority of analysis based on a time of utterance of the conversation during analysis. For example, the analysis unit determines a priority of analysis based on a time of utterance of the conversation during analysis. The analysis unit may preferentially analyze recent conversations. The analysis unit can also preferentially analyze conversations related to specific events. Furthermore, the analysis unit may preferentially analyze conversations that the user has marked as important. By determining a priority of analysis based on a time of utterance of the conversation, important conversations can be preferentially analyzed. Specifically, the analysis unit stores conversation text data received from the recording unit (e.g., about 100 tokens per utterance, with utterance time) in a time-series database and assigns utterance time information and event tags (e.g., birthday, hospital visit, travel, etc.). Examples of input to the AI include “utterance text+utterance time” and “utterance text+event tag.” Example outputs from the AI include “priority analysis list: conversations from the last 24 hours” and “event-related utterance list.” The analysis unit preferentially analyzes utterances with recent times or those linked to specific events, and performs importance scoring and emotion change analysis. Furthermore, for utterances marked as “important” by the user manually or automatically, the analysis unit increases the priority and performs detailed analysis. In subsequent processing, the analysis unit sends analysis results according to priority to the providing unit, enabling users and medical professionals to timely grasp important information. As a technical effect, the analysis unit enables automatic prioritization and optimal allocation of analysis resources for large-scale time-series conversation data, which are difficult to achieve by human subjective judgment or manual work, thereby enabling rapid analysis of important conversations, improving analysis efficiency, and enhancing user experience. Application fields include conversation analysis support for elderly people at home, event management in care facilities, remote medical monitoring, and personal health management applications.

The analysis unit can adjust an order of analysis based on a relevance of the conversation during analysis. For example, the analysis unit adjusts an order of analysis based on a relevance of the conversation during analysis. The analysis unit may preferentially analyze highly relevant conversations. The analysis unit can also preferentially analyze conversations related to the user's areas of interest. Furthermore, the analysis unit may preferentially analyze conversations related to past conversations. By adjusting an order of analysis based on a relevance of the conversation, highly relevant conversations can be preferentially analyzed. Specifically, the analysis unit inputs conversation text data received from the recording unit (e.g., about 100 tokens per utterance) into a large-scale language model for natural language processing, and calculates topic classification for each utterance (e.g., health, hobbies, family, etc.), keyword extraction (TF-IDF or attention weights), and similarity scores with past conversation history (cosine similarity, etc.). Examples of input to the AI include “utterance text+user areas of interest list” and “utterance text+past conversation history.” Example outputs from the AI include “relevance score: 0.9 (health)” and “priority analysis list: similar to past important conversations.” The analysis unit preferentially analyzes utterances with high relevance scores or those matching the user's areas of interest, and performs detailed content analysis and emotion change analysis. Furthermore, for utterances with high similarity to past conversations, the analysis unit applies special analysis algorithms for self-contradiction detection and memory recall support. In subsequent processing, the analysis unit sends analysis results according to relevance to the providing unit, enabling users and medical professionals to efficiently grasp information. As a technical effect, the analysis unit enables automatic relevance judgment and optimal analysis order for large-scale conversation data, which are difficult to achieve by human subjective judgment or manual work, thereby enabling in-depth analysis of important conversations, reducing processing load for unnecessary data, and improving analysis efficiency. Application fields include conversation analysis support for elderly people at home, individual care in care facilities, remote medical monitoring, and personal health management applications.

The providing unit can estimate a user's emotion and adjust a method of expressing provision based on the estimated emotion of the user. For example, the providing unit estimates the user's emotion and adjusts a method of expressing provision based on the estimated emotion. Emotion estimation is realized by using an emotion engine or generative AI, among other emotion estimation functions. Generative AI may include text generation AI (e.g., LLM) or multimodal generative AI, but is not limited to these examples. For instance, when the user is relaxed, the providing unit provides detailed information. When the user is excited, the providing unit may provide concise information. When the user is stressed, the providing unit may provide visually easy-to-understand information. By adjusting the method of expressing provision according to the user's emotion, information that is easy for the user to understand can be provided. Specifically, the providing unit inputs multimodal data such as the user's utterance text, audio features (e.g., MFCC, pitch, spectrogram), and facial images (224×224 pixels) received from the recording unit and analysis unit into an emotion estimation deep neural network (e.g., Transformer+CNN/RNN hybrid model). Examples of input to the AI include “utterance text+audio spectrogram+facial image” and “conversation history+biometric sensor data.” The providing unit receives emotion labels (e.g., relaxed, excited, stressed), emotion scores (e.g., relaxed 0.8, excited 0.1, stressed 0.1), and time-series data of emotion changes as output from the AI. For example, the providing unit can estimate emotion transitions such as “relaxed→excited→stressed” for consecutive utterances. According to the estimated emotion label and score, the providing unit dynamically switches the method of expressing provision (level of detail, degree of summarization, visualization format, etc.). For example, when relaxed, the providing unit generates a detailed text report (e.g., importance score for each utterance, keyword list, time-series graph, etc.); when excited, it generates a concise summary sentence extracting only the main points (e.g., “There are three important utterances today”); and when stressed, it generates analysis results emphasizing visual elements such as graphs and icons (e.g., emotion change chart, color-coded keyword map, etc.). In subsequent processing, the providing unit displays the generated information on a user interface (tablet device, smart speaker, etc.) or outputs it via speech synthesis, enabling information presentation tailored to the user's psychological state. As a technical effect, the providing unit enables real-time emotion estimation and automatic optimization of information expression, which are difficult to achieve by human subjective judgment or manual work, thereby providing information tailored to the user's psychological state, improving understanding, reducing stress, and enhancing user experience. Application fields include conversation analysis support for elderly people at home, psychological care in care facilities, remote medical monitoring, and personal health management applications.

The providing unit can adjust a level of detail of provision based on an importance of the analysis result during provision. For example, the providing unit adjusts a level of detail of provision based on an importance of the analysis result during provision. The providing unit may provide detailed information for important analysis results. The providing unit can also provide concise information for daily analysis results. Furthermore, the providing unit may provide detailed information on emotional changes for emotional analysis results. By adjusting the level of detail of provision based on the importance of the analysis result, important information can be provided in detail. Specifically, the providing unit receives analysis result data (e.g., importance score for each utterance, keyword list, emotion change graph, etc.) from the analysis unit as input and dynamically adjusts the level of detail of the provided information based on the importance score assigned to each analysis result (e.g., continuous value from 0.0 to 1.0). Examples of input to the AI include “analysis result list+importance score” and “utterance text+importance.” The providing unit receives output from the AI such as “detailed provision target list (importance 0.8 or higher)” and “concise provision target list (importance less than 0.3),” and for analysis results with high importance, generates a detailed report including detailed content analysis using TF-IDF, attention weights, topic clustering (LDA, etc.), and time-series analysis of emotional changes. For daily analysis results with low importance, the providing unit generates only a concise summary of main points or a keyword list. When emotional analysis results are detected, the providing unit includes emotion change graphs and time-series transitions of emotion labels in the provided information using an emotion estimation model. In subsequent processing, the providing unit displays information according to the level of detail on the user interface or outputs it via speech synthesis, enabling users and medical professionals to efficiently grasp information. As a technical effect, the providing unit enables automatic importance judgment and optimal allocation of information provision resources for large-scale analysis results, which are difficult to achieve by human subjective judgment or manual work, thereby enabling in-depth provision of important information, reducing processing load for unnecessary data, and improving provision efficiency. Application fields include conversation analysis support for elderly people at home, dementia prevention programs in care facilities, remote medical monitoring, and personal health management applications.

The providing unit can apply different provision algorithms according to the category of the analysis result at the time of provision. For example, the providing unit applies different provision algorithms according to the category of the analysis result at the time of provision. For instance, for analysis results related to the home, the providing unit applies provision algorithms specialized for home topics. For analysis results related to work, the providing unit can apply business-related provision algorithms. For emotional analysis results, the providing unit can also apply emotion analysis algorithms. By applying different provision algorithms according to the category of the analysis result, more appropriate information can be provided. Specifically, the providing unit receives analysis result data (e.g., approximately 100 tokens per utterance, with category labels) from the analysis unit as input, and first confirms category labels such as “home,” “business,” or “emotional” using a topic classification model (e.g., BERT-based multi-class classifier). As input examples for AI, the providing unit can use “analysis result text+candidate category list” or “analysis result text+past category distribution.” The providing unit receives outputs from AI such as “category label: home,” “category label: business,” or “category label: emotional,” and, according to the category label, applies rule-based provision specialized for family relationships or home events (e.g., emphasizing family member names, notifying home events) for home analysis results, business terminology dictionaries or project progress notification algorithms for business analysis results, and emotion change graphs or stress reduction advice using emotion estimation models for emotional analysis results. Furthermore, the providing unit generates different information formats for each category (e.g., relationship graphs for home, task progress charts for business, time-series emotion score graphs for emotional) and outputs them in an optimal form for the user interface. As a subsequent process, the providing unit presents the category-specific provision results to users or medical professionals to support situation-appropriate information understanding. As a technical effect, the providing unit realizes automatic algorithm selection and optimal information provision for each analysis category, which is difficult with human subjective judgment or manual work, thereby improving provision accuracy, reducing the processing load of unnecessary data, and enhancing user experience. Application fields include conversation analysis support for homebound elderly, diverse conversation management in care facilities, remote medical monitoring, and personal health management applications.

The providing unit can estimate a user's emotion and adjust the length of provision based on the estimated emotion of the user. For example, the providing unit estimates a user's emotion and adjusts the length of provision based on the estimated emotion. Emotion estimation is realized using an emotion engine or generative AI, such as a text generation AI (e.g., LLM) or multimodal generative AI, but is not limited to these examples. For instance, when the user is relaxed, the providing unit provides detailed information for a longer duration. When the user is excited, the providing unit can provide concise information for a shorter duration. When the user is stressed, the providing unit can provide short, visually easy-to-understand information. By adjusting the length of provision according to the user's emotion, information of an appropriate length can be provided to the user. Specifically, the providing unit inputs utterance text, audio features, facial images, etc., received from the recording unit or analysis unit, into a multimodal emotion estimation model (Transformer+CNN/RNN hybrid) to estimate emotion labels (relaxed, excited, stressed) and emotion scores (e.g., relaxed 0.7, excited 0.2, stressed 0.1). Input examples for AI include “utterance text+audio spectrogram” or “conversation history+facial images.” The providing unit receives outputs from AI such as “emotion label: relaxed” or “emotion score: relaxed 0.7,” and dynamically adjusts the length (level of detail, degree of summarization) of the provided information according to the emotion label and score. For example, when relaxed, a detailed information report (e.g., importance score per utterance, keyword list, time-series graph) is generated for a longer duration; when excited, a short summary extracting only the main points (e.g., “There are three important utterances today”) is generated; and when stressed, short information emphasizing visual elements such as graphs or icons (e.g., emotion change chart, color-coded keyword map) is generated. As a subsequent process, the providing unit outputs information according to its length to the user interface, realizing information presentation tailored to the user's psychological state. As a technical effect, the providing unit realizes real-time emotion estimation and automatic optimization of information length, which are difficult with human subjective judgment or manual work, thereby improving user comprehension, reducing stress, and enhancing user experience. Application fields include conversation analysis support for homebound elderly, psychological care in care facilities, remote medical monitoring, and personal health management applications.

The providing unit can determine the priority of provision based on the time of utterance of the analysis result at the time of provision. For example, the providing unit determines the priority of provision based on the time of utterance of the analysis result at the time of provision. For instance, the providing unit preferentially provides recent analysis results. The providing unit can also preferentially provide analysis results related to specific events. Furthermore, the providing unit can preferentially provide analysis results that the user has marked as important. By determining the priority of provision based on the time of utterance of the analysis result, important information can be provided preferentially. Specifically, the providing unit stores analysis result data (e.g., approximately 100 tokens per utterance, with utterance time and event tags) received from the analysis unit in a time-series database and refers to utterance time information and event tags (e.g., birthday, hospital visit, travel, etc.). Input examples for AI include “analysis result text+utterance time” or “analysis result text+event tag.” The providing unit receives outputs from AI such as “priority provision list: analysis results from the last 24 hours” or “event-related analysis result list,” and preferentially provides analysis results with newer utterance times or those linked to specific events, generating information including importance scores and emotion change analysis. Furthermore, for analysis results marked as “important” by the user manually or automatically, the priority is increased and detailed information is provided. As a subsequent process, the providing unit displays or outputs information according to priority on the user interface or via speech synthesis, enabling users or medical professionals to timely grasp important information. As a technical effect, the providing unit realizes automatic prioritization of large-scale time-series analysis results and optimal allocation of information provision resources, which are difficult with human subjective judgment or manual work, thereby enabling rapid provision of important information, improving provision efficiency, and enhancing user experience. Application fields include conversation analysis support for homebound elderly, event management in care facilities, remote medical monitoring, and personal health management applications.

The providing unit can adjust the order of provision based on the relevance of the analysis result at the time of provision. For example, the providing unit adjusts the order of provision based on the relevance of the analysis result at the time of provision. For instance, the providing unit preferentially provides highly relevant analysis results. The providing unit can also preferentially provide analysis results related to the user's areas of interest. Furthermore, the providing unit can preferentially provide analysis results related to past analysis results. By adjusting the order of provision based on the relevance of the analysis result, highly relevant information can be provided preferentially. Specifically, the providing unit receives analysis result data (e.g., approximately 100 tokens per utterance, topic classification, keyword list, similarity score with past analysis results) from the analysis unit as input, and calculates topic classification (e.g., health, hobbies, family, etc.), keyword extraction (TF-IDF or attention weights), and similarity scores with past analysis results (e.g., cosine similarity). Input examples for AI include “analysis result text+user areas of interest list” or “analysis result text+past analysis result history.” The providing unit receives outputs from AI such as “relevance score: 0.9 (health)” or “priority provision list: similar to past important analysis results,” and preferentially provides analysis results with high relevance scores or those matching the user's areas of interest, generating information including detailed content and emotion change analysis. Furthermore, for analysis results with high similarity to past analysis results, special information provision algorithms for self-contradiction detection or memory recall support are applied. As a subsequent process, the providing unit displays or outputs information according to relevance on the user interface or via speech synthesis, enabling users or medical professionals to efficiently grasp information. As a technical effect, the providing unit realizes automatic relevance determination and optimization of information provision order for large-scale analysis results, which are difficult with human subjective judgment or manual work, thereby enabling in-depth provision of important information, reducing the processing load of unnecessary data, and improving provision efficiency. Application fields include conversation analysis support for homebound elderly, individualized care in care facilities, remote medical monitoring, and personal health management applications.

The topic providing unit can estimate a user's emotion and adjust the method of providing topics based on the estimated emotion of the user. For example, the topic providing unit estimates a user's emotion and adjusts the method of providing topics based on the estimated emotion. Emotion estimation is realized using an emotion engine or generative AI, such as a text generation AI (e.g., LLM) or multimodal generative AI, but is not limited to these examples. For instance, when the user is relaxed, the topic providing unit provides detailed topics. When the user is excited, the topic providing unit can provide concise topics. When the user is stressed, the topic providing unit can provide visually easy-to-understand topics. By adjusting the method of providing topics according to the user's emotion, topics that are easy for the user to understand can be provided. Specifically, the topic providing unit inputs multimodal data such as the user's utterance text, audio features (e.g., MFCC, pitch, spectrogram), and facial images (224×224 pixels) received from the recording unit or analysis unit into a deep neural network for emotion estimation (e.g., Transformer+CNN/RNN hybrid model). Input examples for AI include “utterance text+audio spectrogram+facial image” or “conversation history+biometric sensor data.” The topic providing unit receives outputs from AI such as emotion labels (e.g., relaxed, excited, stressed), emotion scores (e.g., relaxed 0.8, excited 0.1, stressed 0.1), and time-series data of emotion changes. For example, emotion transitions such as “relaxed→excited→stressed” can be estimated for consecutive utterances. According to the estimated emotion label and score, the topic providing unit dynamically switches the prompt content and generation parameters for the topic generation AI (large language model). For example, when relaxed, detailed instructions such as “Generate three detailed old stories about the user's place of origin” are given; when excited, concise instructions such as “Generate one main point about recent events” are given; and when stressed, instructions such as “Generate visually easy-to-understand topics (e.g., topic sentences with illustrations or short question sentences)” are given. Example AI outputs include “Do you have any memories of snowball fights in winter when you were a child?” (detailed topic), “What was the most enjoyable thing recently?” (concise topic), and “Does this illustration remind you of anything?” (visual topic). The topic providing unit displays or outputs the generated topic sentences on the user interface (tablet device, smart speaker, etc.) via speech synthesis, realizing topic presentation tailored to the user's psychological state. As a subsequent process, the topic providing unit feeds back the user's reactions and conversation content to the recording unit and analysis unit, continuously optimizing and personalizing the topic generation algorithm parameters. As a technical effect, the topic providing unit realizes real-time emotion estimation and automatic optimization of topic provision methods, which are difficult with human subjective judgment or manual work, thereby enabling topic presentation tailored to the user's psychological state, improving comprehension, reducing stress, and enhancing user experience. Application fields include conversation support for homebound elderly, psychological care in care facilities, remote medical monitoring, and personal health management applications.

The topic providing unit can refer to the user's past conversation history at the time of topic provision to select appropriate topics. For example, the topic providing unit refers to the user's past conversation history at the time of topic provision to select appropriate topics. For instance, the topic providing unit provides topics related to topics the user has discussed in the past. The topic providing unit can also select topics that the user is likely to be interested in from the user's past conversation history. Furthermore, the topic providing unit can analyze the user's past conversation patterns and provide optimal topics. By referring to the user's past conversation history, topics of interest to the user can be provided. Specifically, the topic providing unit obtains conversation text data for the past week to month (e.g., 1,000 tokens per day×7 days=7,000 tokens) from the database and inputs it into a large language model for natural language processing (e.g., Transformer-based encoder-decoder model). The topic providing unit tokenizes the input text and generates word embeddings (BERT embedding, dimension 768). The topic providing unit extracts topic distribution of conversations (e.g., topic clustering by LDA), frequent keyword lists (top 10 by TF-IDF score), and conversation patterns (e.g., morning greetings, nighttime health topics as time-series patterns). Input examples for AI include “conversation text sequence for the past 7 days” or “list of past utterance times and contents.” Example AI outputs include “frequent topics: health, family, hobbies,” “important keywords: memory, exercise, diet,” and “recommended topic timing: 7-8 a.m., 8-9 p.m.” The topic providing unit automatically generates prompts for the topic generation AI (e.g., “Generate three new topics about health, which the user has frequently discussed in the past”) and topic selection parameters (e.g., priority score for each topic) based on these outputs. As a subsequent process, the topic providing unit dynamically controls topic provision by preferentially generating related topics when important topics or keywords extracted from past history appear in newly acquired conversation data in real time, or by switching topic provision modes when specific conversation patterns are detected. As a technical effect, the topic providing unit realizes automatic analysis of large-scale history data and optimization of topic selection, which are difficult with human experience or manual work, thereby enabling comprehensive provision of topics tailored to the user's interests and concerns, improving topic provision efficiency, and enabling individual optimization for each user. Application fields include conversation support for homebound elderly, recreation in care facilities, remote medical support, and personal health management applications.

The topic providing unit can customize the content of topics based on the user's current living situation at the time of topic provision. For example, the topic providing unit customizes the content of topics based on the user's current living situation at the time of topic provision. For instance, the topic providing unit provides topics related to topics the user is currently interested in. The topic providing unit can also select optimal topics according to the user's living situation. Furthermore, the topic providing unit can provide highly relevant topics based on the user's areas of interest. By customizing topics based on the user's current living situation, highly relevant topics can be provided. Specifically, the topic providing unit refers to the user profile database (e.g., living situation=homebound, areas of interest=gardening, health, travel) and recent activity history (e.g., activity logs from smartwatches, calendar schedules) to generate customization conditions. The topic providing unit inputs real-time acquired conversation text (e.g., approximately 100 tokens per utterance) into a large language model for natural language processing, and calculates topic classification for each utterance (e.g., gardening, health, travel, family, etc.) and interest score (0.0-1.0). Input examples for AI include “utterance text+user areas of interest list” or “utterance text+living situation tag.” Example AI outputs include “utterance topic: gardening, interest score 0.9” and “utterance topic: health, interest score 0.7.” The topic providing unit preferentially generates topics related to topics with interest scores above a predetermined threshold (e.g., 0.7), while reducing the frequency or excluding other topics from provision. As a subsequent process, the topic providing unit notifies the user interface of the customization results, realizing topic presentation tailored to the user's living situation and areas of interest. As a technical effect, the topic providing unit realizes real-time linkage with living situation and topic customization, which are difficult with human subjective judgment or manual work, thereby improving the relevance of topic provision data, reducing unnecessary topics, and enhancing user experience. Application fields include conversation support for homebound elderly, individualized care support in care facilities, remote medical monitoring, and personal health management applications.

The topic providing unit can estimate a user's emotion and determine the priority of topics based on the estimated emotion of the user. For example, the topic providing unit estimates a user's emotion and determines the priority of topics based on the estimated emotion. Emotion estimation is realized using an emotion engine or generative AI, such as a text generation AI (e.g., LLM) or multimodal generative AI, but is not limited to these examples. For instance, when the user is relaxed, the topic providing unit preferentially provides everyday topics. When the user is excited, the topic providing unit can preferentially provide important topics. When the user is stressed, the topic providing unit can preferentially provide emotional topics. By determining the priority of topics according to the user's emotion, important topics can be provided preferentially. Specifically, the topic providing unit inputs the user's utterance audio data (e.g., 16 kHz/16 bit PCM waveform, 80,000 samples in 5 seconds), utterance text, and facial images (224×224 pixels) into a deep neural network for emotion estimation (CNN+RNN hybrid model or Transformer-based multimodal model). Input examples for AI include audio spectrogram (128×100), utterance text, and facial images. Example AI outputs include emotion labels (relaxed, excited, stressed), emotion scores (relaxed 0.7, excited 0.2, stressed 0.1), and emotion change flags for each utterance. Based on the emotion estimation results, the topic providing unit assigns a topic priority score (0.0-1.0) to each topic candidate and preferentially generates and provides topics with high priority (e.g., important topics when excited, emotional topics when stressed). As a subsequent process, the topic providing unit selects topic provision targets, dynamically adjusts provision frequency, and adds priority topic flags to the user interface according to the priority score. As a technical effect, the topic providing unit realizes real-time emotion estimation and optimization of topic priority, which are difficult with human subjective judgment or manual work, thereby enabling comprehensive provision of important topics, improving topic provision efficiency, and enhancing user experience. Application fields include conversation support for homebound elderly, psychological care support in care facilities, remote medical monitoring, and personal health management applications.

The topic providing unit can select appropriate topics by considering the user's geographic location information at the time of topic provision. For example, the topic providing unit selects appropriate topics by considering the user's geographic location information at the time of topic provision. For instance, when the user is in a specific location, the topic providing unit provides topics related to that location. When the user is traveling, the topic providing unit can provide topics related to the travel destination. When the user is at home, the topic providing unit can provide home-related topics. By considering the user's geographic location information, highly relevant topics can be provided. Specifically, the topic providing unit acquires the user's current location information (e.g., latitude and longitude, facility name, room number, etc.) in real time from GPS sensors or Wi-Fi/Bluetooth beacons and links it with conversation record data. The topic providing unit inputs conversation text (e.g., approximately 100 tokens per utterance) and current location information into a large language model for natural language processing, and calculates the relevance score (0.0-1.0) between the utterance content and geographic location information. Input examples for AI include “utterance text+current location: home” or “utterance text+current location: travel destination (Kyoto).” Example AI outputs include “relevance score: 0.9 (travel destination related)” and “relevance score: 0.8 (home related).” The topic providing unit preferentially generates topics with relevance scores above a predetermined threshold (e.g., 0.7), while reducing the frequency or excluding other topics from provision. As a subsequent process, the topic providing unit displays or outputs topic data with geographic location information on the user interface via speech synthesis, utilizing it for location-dependent topic presentation and feedback. As a technical effect, the topic providing unit realizes real-time linkage with location information and topic optimization, which are difficult with human subjective judgment or manual work, thereby improving the relevance of topic provision data, reducing unnecessary topics, and enhancing user experience. Application fields include monitoring the lives of homebound elderly, behavior recording in care facilities, health management during travel, and personal life log applications.

The topic providing unit can analyze the user's social media activity at the time of topic provision and provide related topics. For example, the topic providing unit analyzes the user's social media activity at the time of topic provision and provides related topics. For instance, the topic providing unit provides topics related to topics the user is discussing on social media. The topic providing unit can also analyze the user's social media posts and provide highly relevant topics. Furthermore, the topic providing unit can preferentially provide conversations with the user's social media friends. By analyzing the user's social media activity, highly relevant topics can be provided. Specifically, the topic providing unit periodically acquires structured data such as the latest post data, comment history, friend list, and trending words from multiple social media platforms used by the user (e.g., text-based SNS, image sharing services, microblogging services) via APIs. The topic providing unit inputs the acquired post data (e.g., up to 500 tokens per post, post time, post category, friend tags, etc.) into a large language model for natural language processing (e.g., Transformer-based encoder-decoder model), and performs topic classification of post content (e.g., health, hobbies, family, travel, etc.), keyword extraction (TF-IDF or attention weighting), and friend network analysis (e.g., clustering by graph neural networks). Input examples for AI include “post text for the past week+friend list” or “latest trending words+conversation text.” Example AI outputs include “priority topic: health, travel,” “related friends: Mr. A, Mr. B,” and “post keywords: exercise, memories.” The topic providing unit calculates the relevance score (0.0-1.0) between real-time acquired conversation text and social media-derived topics/keywords based on these outputs, and preferentially generates topics with relevance scores above a predetermined threshold (e.g., 0.7). Furthermore, when conversations with friends are detected, the topic providing unit links friend IDs and conversation content to the topic generation prompt and utilizes them for subsequent topic presentation and feedback on the user interface. As a technical effect, the topic providing unit realizes automatic analysis of large-scale social media data and optimization of topic provision, which are difficult with human subjective judgment or manual work, thereby enabling comprehensive provision of important topics tailored to the user's social interests and network activities, improving topic provision efficiency, and enabling individual optimization for each user. Application fields include support for preventing social isolation of homebound elderly, exchange promotion programs in care facilities, remote medical support, and personal health management/life log applications.

The feedback unit can estimate a user's emotion and adjust the method of feedback based on the estimated emotion of the user. For example, the feedback unit estimates a user's emotion and adjusts the method of feedback based on the estimated emotion. Emotion estimation is realized using an emotion engine or generative AI, such as a text generation AI (e.g., LLM) or multimodal generative AI, but is not limited to these examples. For instance, when the user is relaxed, the feedback unit provides detailed feedback. When the user is excited, the feedback unit can provide concise feedback. When the user is stressed, the feedback unit can provide visually easy-to-understand feedback. By adjusting the method of feedback according to the user's emotion, feedback that is easy for the user to understand can be provided. Specifically, the feedback unit inputs multimodal data such as the user's utterance text (e.g., 1,000 tokens per day of conversation), audio features (e.g., MFCC, pitch, spectrogram), and facial images (224×224 pixels) received from the recording unit or analysis unit into a deep neural network for emotion estimation (e.g., Transformer+CNN/RNN hybrid model). Input examples for AI include “utterance text+audio spectrogram+facial image” or “conversation history+biometric sensor data.” The feedback unit receives outputs from AI such as emotion labels (e.g., relaxed, excited, stressed), emotion scores (e.g., relaxed 0.8, excited 0.1, stressed 0.1), and time-series data of emotion changes. For example, emotion transitions such as “relaxed→excited→stressed” can be estimated for consecutive utterances. According to the estimated emotion label and score, the feedback unit dynamically switches the expression method of feedback information (level of detail, degree of summarization, visualization format, etc.). For example, when relaxed, a detailed text report (e.g., importance score per utterance, keyword list, time-series graph) is generated; when excited, a concise summary extracting only the main points (e.g., “This week's memory score is +5% compared to last week”) is generated; and when stressed, feedback emphasizing visual elements such as graphs or icons (e.g., emotion change chart, color-coded keyword map) is generated. As a subsequent process, the feedback unit displays or outputs the generated feedback information on the user interface (tablet device, smart speaker, etc.) via speech synthesis, realizing information presentation tailored to the user's psychological state. Furthermore, the feedback unit feeds back the user's reactions and feedback history to the recording unit and analysis unit, continuously optimizing and personalizing the feedback method parameters. As a technical effect, the feedback unit realizes real-time emotion estimation and automatic optimization of feedback methods, which are difficult with human subjective judgment or manual work, thereby enabling information presentation tailored to the user's psychological state, improving comprehension, reducing stress, and enhancing user experience. Application fields include health management feedback for homebound elderly, psychological care support in care facilities, remote medical monitoring, and personal health management applications.

The feedback unit can refer to the user's past conversation history at the time of feedback to provide optimal feedback. For example, the feedback unit refers to the user's past conversation history at the time of feedback to provide optimal feedback. For instance, the feedback unit provides feedback related to topics the user has discussed in the past. The feedback unit can also provide feedback that the user is likely to be interested in from the user's past conversation history. Furthermore, the feedback unit can analyze the user's past conversation patterns and provide optimal feedback. By referring to the user's past conversation history, feedback of interest to the user can be provided. Specifically, the feedback unit obtains conversation text data for the past week to month (e.g., 1,000 tokens per day×7 days=7,000 tokens) from the database and inputs it into a large language model for natural language processing (e.g., Transformer-based encoder-decoder model). The feedback unit tokenizes the input text and generates word embeddings (BERT embedding, dimension 768). The feedback unit extracts topic distribution of conversations (e.g., topic clustering by LDA), frequent keyword lists (top 10 by TF-IDF score), and conversation patterns (e.g., morning greetings, nighttime health topics as time-series patterns). Input examples for AI include “conversation text sequence for the past 7 days” or “list of past utterance times and contents.” Example AI outputs include “frequent topics: health, family, hobbies,” “important keywords: memory, exercise, diet,” and “recommended feedback timing: 7-8 a.m., 8-9 p.m.” The feedback unit automatically generates prompts for the feedback generation AI (e.g., “Generate three new feedback items about health, which the user has frequently discussed in the past”) and feedback selection parameters (e.g., priority score for each topic) based on these outputs. As a subsequent process, the feedback unit dynamically controls feedback provision by preferentially generating related feedback when important topics or keywords extracted from past history appear in newly acquired conversation data in real time, or by switching feedback modes when specific conversation patterns are detected. As a technical effect, the feedback unit realizes automatic analysis of large-scale history data and optimization of feedback selection, which are difficult with human experience or manual work, thereby enabling comprehensive provision of feedback tailored to the user's interests and concerns, improving feedback efficiency, and enabling individual optimization for each user. Application fields include health management feedback for homebound elderly, recreation in care facilities, remote medical support, and personal health management applications.

The feedback unit can customize the content of feedback based on the user's current living situation at the time of feedback. For example, the feedback unit customizes the content of feedback based on the user's current living situation at the time of feedback. For instance, the feedback unit provides feedback related to topics the user is currently interested in. The feedback unit can also provide optimal feedback according to the user's living situation. Furthermore, the feedback unit can provide highly relevant feedback based on the user's areas of interest. By customizing feedback based on the user's current living situation, highly relevant feedback can be provided. Specifically, the feedback unit refers to the user profile database (e.g., living situation=homebound, areas of interest=gardening, health, travel) and recent activity history (e.g., activity logs from smartwatches, calendar schedules) to generate customization conditions. The feedback unit inputs real-time acquired conversation text (e.g., approximately 100 tokens per utterance) into a large language model for natural language processing, and calculates topic classification for each utterance (e.g., gardening, health, travel, family, etc.) and interest score (0.0-1.0). Input examples for AI include “utterance text+user areas of interest list” or “utterance text+living situation tag.” Example AI outputs include “utterance topic: gardening, interest score 0.9” and “utterance topic: health, interest score 0.7.” The feedback unit preferentially generates feedback related to topics with interest scores above a predetermined threshold (e.g., 0.7), while reducing the frequency or excluding other feedback from provision. As a subsequent process, the feedback unit notifies the user interface of the customization results, realizing feedback presentation tailored to the user's living situation and areas of interest. As a technical effect, the feedback unit realizes real-time linkage with living situation and feedback customization, which are difficult with human subjective judgment or manual work, thereby improving the relevance of feedback data, reducing unnecessary feedback, and enhancing user experience. Application fields include health management support for homebound elderly, individualized care support in care facilities, remote medical monitoring, and personal health management applications.

The feedback unit can estimate a user's emotion and determine the priority of feedback based on the estimated emotion of the user. For example, the feedback unit estimates a user's emotion and determines the priority of feedback based on the estimated emotion. Emotion estimation is realized using an emotion engine or generative AI, such as a text generation AI (e.g., LLM) or multimodal generative AI, but is not limited to these examples. For instance, when the user is relaxed, the feedback unit preferentially provides everyday feedback. When the user is excited, the feedback unit can preferentially provide important feedback. When the user is stressed, the feedback unit can preferentially provide emotional feedback. By determining the priority of feedback according to the user's emotion, important feedback can be provided preferentially. Specifically, the feedback unit inputs the user's utterance audio data (e.g., 16 kHz/16 bit PCM waveform, 80,000 samples in 5 seconds), utterance text, and facial images (224×224 pixels) into a deep neural network for emotion estimation (CNN+RNN hybrid model or Transformer-based multimodal model). Input examples for AI include audio spectrogram (128×100), utterance text, and facial images. Example AI outputs include emotion labels (relaxed, excited, stressed), emotion scores (relaxed 0.7, excited 0.2, stressed 0.1), and emotion change flags for each utterance. Based on the emotion estimation results, the feedback unit assigns a feedback priority score (0.0-1.0) to each feedback candidate and preferentially generates and provides feedback with high priority (e.g., important feedback when excited, emotional feedback when stressed). As a subsequent process, the feedback unit selects feedback provision targets, dynamically adjusts provision frequency, and adds priority feedback flags to the user interface according to the priority score. As a technical effect, the feedback unit realizes real-time emotion estimation and optimization of feedback priority, which are difficult with human subjective judgment or manual work, thereby enabling comprehensive provision of important feedback, improving feedback efficiency, and enhancing user experience. Application fields include health management feedback for homebound elderly, psychological care support in care facilities, remote medical monitoring, and personal health management applications.

The feedback unit can provide appropriate feedback by considering the user's geographic location information at the time of feedback. For example, the feedback unit provides appropriate feedback by considering the user's geographic location information at the time of feedback. For instance, when the user is in a specific location, the feedback unit provides feedback related to that location. When the user is traveling, the feedback unit can provide feedback related to the travel destination. When the user is at home, the feedback unit can provide home-related feedback. By considering the user's geographic location information, highly relevant feedback can be provided. Specifically, the feedback unit acquires the user's current location information (e.g., latitude and longitude, facility name, room number, etc.) in real time from GPS sensors or Wi-Fi/Bluetooth beacons and links it with conversation record data and analysis results. The feedback unit inputs analysis result text (e.g., approximately 100 tokens per utterance) and current location information into a large language model for natural language processing, and calculates the relevance score (0.0-1.0) between the analysis content and geographic location information. Input examples for AI include “analysis result text+current location: home” or “analysis result text+current location: travel destination (Kyoto).” Example AI outputs include “relevance score: 0.9 (travel destination related)” and “relevance score: 0.8 (home related).” The feedback unit preferentially generates feedback with relevance scores above a predetermined threshold (e.g., 0.7), while reducing the frequency or excluding other feedback from provision. As a subsequent process, the feedback unit displays or outputs feedback data with geographic location information on the user interface via speech synthesis, utilizing it for location-dependent feedback presentation and feedback history management. As a technical effect, the feedback unit realizes real-time linkage with location information and feedback optimization, which are difficult with human subjective judgment or manual work, thereby improving the relevance of feedback data, reducing unnecessary feedback, and enhancing user experience. Application fields include monitoring the lives of homebound elderly, behavior recording in care facilities, health management during travel, and personal life log applications.

The feedback unit can analyze the user's social media activity at the time of feedback and propose the content of feedback. For example, the feedback unit analyzes the user's social media activity at the time of feedback and proposes the content of feedback. For instance, the feedback unit provides feedback related to topics the user is discussing on social media. The feedback unit can also analyze the user's social media posts and provide highly relevant feedback. Furthermore, the feedback unit can provide feedback with the user's social media friends. By analyzing the user's social media activity, highly relevant feedback can be provided. Specifically, the feedback unit periodically acquires structured data such as the latest post data, comment history, friend list, and trending words from multiple social media platforms used by the user (e.g., text-based SNS, image sharing services, microblogging services) via APIs. The feedback unit inputs the acquired post data (e.g., up to 500 tokens per post, post time, post category, friend tags, etc.) into a large language model for natural language processing (e.g., Transformer-based encoder-decoder model), and performs topic classification of post content (e.g., health, hobbies, family, travel, etc.), keyword extraction (TF-IDF or attention weighting), and friend network analysis (e.g., clustering by graph neural networks). Input examples for AI include “post text for the past week+friend list” or “latest trending words+conversation text.” Example AI outputs include “priority feedback topic: health, travel,” “related friends: Mr. A, Mr. B,” and “post keywords: exercise, memories.” The feedback unit calculates the relevance score (0.0-1.0) between real-time acquired conversation text and social media-derived topics/keywords based on these outputs, and preferentially generates feedback with relevance scores above a predetermined threshold (e.g., 0.7). Furthermore, when conversations with friends are detected, the feedback unit links friend IDs and conversation content to the feedback generation prompt and utilizes them for subsequent feedback presentation and history management on the user interface. As a technical effect, the feedback unit realizes automatic analysis of large-scale social media data and optimization of feedback, which are difficult with human subjective judgment or manual work, thereby enabling comprehensive provision of important feedback tailored to the user's social interests and network activities, improving feedback efficiency, and enabling individual optimization for each user. Application fields include support for preventing social isolation of homebound elderly, exchange promotion programs in care facilities, remote medical support, and personal health management/life log applications.

The system according to the embodiment is not limited to the examples described above and can be variously modified as follows, for example. Specifically, the system can flexibly change the architecture of AI models, data flow, input/output specifications, control parameters, etc., in each component such as the recording unit, analysis unit, providing unit, and feedback unit. The system can employ, as a speech recognition model, not only encoder-decoder type recurrent neural networks or Transformer-based models, but also convolutional neural networks or self-supervised learning models. As for natural language processing models, BERT, GPT series, LSTM-based models, or ensemble configurations of multiple models can be used. Furthermore, in emotion estimation processing, various multimodal inputs such as audio, text, images, and biometric sensor data can be combined, and time-series analysis or anomaly detection algorithms (e.g., anomaly score calculation by autoencoders) can be added. The recording unit can target not only user conversations but also ambient sounds, environmental sounds, activity logs, and biometric information from wearable devices, and the analysis unit can integratively analyze these diverse data to realize more accurate cognitive function evaluation and health status estimation. The providing unit and feedback unit can dynamically switch output formats (text, audio, images, graphs, animations, etc.) and notification means (smartphones, wearable devices, IoT home appliances, etc.) according to user attributes and usage environments. As a technical effect, the system realizes adaptability to diverse user attributes and usage environments, significant improvement in analysis accuracy, speed, and scalability, and individually optimized dementia prevention and health management support, which were difficult with conventional single-modality and single-model processing. Application fields include monitoring of homebound elderly, diverse care programs in care facilities, remote medical support, personal health management/life log applications, and employee health management systems for companies.

The recording unit can also translate the user's conversation audio data in real time and record it in multiple languages. For example, content spoken by the user in English can be translated into Japanese or Spanish and recorded as text data in each language. Furthermore, even when the user speaks in different languages, the recording unit can translate all conversations into a unified language and record them. This enables centralized recording of conversations and facilitates analysis by the analysis unit, even when the user lives in a multilingual environment. Specifically, the recording unit acquires the user's utterance audio data (e.g., 16 kHz/16 bit PCM waveform, 80,000 samples in 5 seconds) using a high-precision microphone array and inputs it into a speech recognition model (e.g., Transformer-based encoder-decoder model) to extract utterance text. The extracted text data is input into a neural machine translation model (e.g., Transformer-based multilingual translation model, NMT) to perform translation into specified multiple languages (e.g., Japanese, Spanish, French, etc.). Input examples for AI include “English utterance text: How are you today?” and “Japanese utterance text: [symbol] ?”, and example AI outputs include “Japanese translation: [symbol] ?” and “Spanish translation: ¿Cómo estás hoy?” The recording unit saves the translation results in a record database with timestamps for each language, and the analysis unit performs subsequent processing such as natural language processing, emotion analysis, and keyword extraction using unified language or multilingual data. Furthermore, the recording unit can automatically determine the priority language or frequently used language based on the user profile and optimize the recording language. As a technical effect, the recording unit realizes real-time multilingual translation and recording processing, which are difficult with manual work, improves analysis efficiency through language unification, and enables flexible response to multilingual environments. Application fields include conversation recording in multilingual households, international care facilities, global remote medical support, and personal multilingual health management applications.

The analysis unit can also analyze the tone and speed of the user's conversation and estimate the user's stress level. For example, when the user speaks rapidly, it is estimated that the stress level is high, and conversely, when the user speaks slowly, it is estimated that the user is relaxed. Furthermore, the analysis unit can use the pitch of the user's voice, whether high or low, as an indicator of stress level. By grasping the user's stress level, appropriate feedback and support can be provided. Specifically, the analysis unit processes utterance audio data (e.g., 16 kHz/16 bit PCM waveform, 80,000 samples in 5 seconds) received from the recording unit using an acoustic feature extraction module to generate features such as MFCC, pitch, zero-crossing rate, speech speed (number of phonemes or words per unit time), and volume variation. These acoustic features are input into a deep neural network for stress estimation (e.g., CNN+RNN hybrid model or Transformer-based speech analysis model). Input examples for AI include “audio spectrogram (128×100)+speech speed: 200 words per minute” or “audio feature vector+average pitch value.” Example AI outputs include “stress level score: 0.85 (high),” “stress estimation label: high stress,” and “relaxation estimation label: low stress.” When the stress level score is high, the analysis unit notifies the feedback unit or providing unit with a stress warning flag, prompting the provision of stress reduction advice or relaxation promotion information to the user. Furthermore, changes in stress level are graphed over time to enable users or medical professionals to grasp stress trends. As a technical effect, the analysis unit realizes real-time acoustic feature analysis and stress level estimation, which are difficult with human subjective judgment or manual work, enabling quantitative grasp of the user's psychological state, early stress detection, and individually optimized support provision. Application fields include psychological care for homebound elderly, stress management in care facilities, remote medical monitoring, and personal health management applications.

The providing unit may also include a health information providing unit that provides information related to the user's health status. For example, health-related topics can be extracted from the user's conversation content and appropriate health information can be provided. Furthermore, the providing unit can provide appropriate answers to questions regarding the user's health status. Additionally, the providing unit can periodically provide feedback on information related to the user's health status, making it easier for the user to understand their own health status. This supports the user's health management and contributes to dementia prevention. Specifically, the health information providing unit compares conversation text data and keyword extraction results (e.g., health, exercise, diet, sleep, etc.) received from the analysis unit with a health information database and the latest medical guidelines, and automatically generates related health advice and cautionary information. Input examples for AI include “utterance text: I haven't been sleeping well lately” and “keyword list: sleep, fatigue,” and example AI outputs include “advice for improving sleep” and “diet information helpful for fatigue recovery.” The health information providing unit analyzes questions from the user regarding health status (e.g., “What should I do to lower my blood pressure?”) using a natural language understanding model and extracts/generates optimal answers from an FAQ database or medical knowledge graph. Furthermore, the user's health status scores (e.g., activity level, sleep duration, weight change, etc.) are aggregated over time and periodically notified to the user, family, or medical professionals via the feedback unit. As a technical effect, the health information providing unit realizes automatic analysis of large-scale health data and individually optimized health information provision, which are difficult with human subjective judgment or manual work, thereby supporting user health management, dementia prevention, and advanced measures against lifestyle-related diseases. Application fields include health management for homebound elderly, health guidance in care facilities, remote medical support, and personal health management applications.

The providing unit may estimate a user's emotion and adjust the content of information to be provided based on the estimated emotion. For example, when the user is relaxed, the providing unit provides topics or information suitable for relaxation. When the user is feeling stressed, information helpful for stress reduction may be provided. Furthermore, when the user is excited, information to calm the excitement may be provided. In this way, appropriate information can be provided according to the user's emotion, thereby promoting psychological stability for the user. Specifically, the providing unit inputs utterance text, audio features, facial images, etc. received from the recording unit and analysis unit into a multimodal emotion estimation model (Transformer+CNN/RNN hybrid), and estimates emotion labels (relaxation, excitement, stress) and emotion scores (e.g., relaxation 0.7, excitement 0.2, stress 0.1). Examples of input to the AI include “utterance text+audio spectrogram” and “conversation history+facial image.” The providing unit receives outputs such as “emotion label: relaxation” and “emotion score: relaxation 0.7” from the AI, and dynamically adjusts the content of the information to be provided (topic selection, advice content, expression method, etc.) according to the emotion label and score. For example, during relaxation, positive topics such as hobbies or reminiscences are generated and provided; during stress, relaxation methods or stress reduction advice are prioritized; and during excitement, information to promote calmness or cautionary notices are preferentially generated and provided. As a subsequent process, the providing unit displays the generated information on the user interface or outputs it via speech synthesis, thereby presenting information tailored to the user's psychological state. As a technical effect, the providing unit realizes real-time emotion estimation and automatic optimization of information content, which are difficult to achieve by human subjective judgment or manual work, thereby improving psychological stability, comprehension, stress reduction, and user experience. Application fields include psychological care for elderly people at home, conversation support in nursing facilities, remote medical monitoring, and personal health management applications.

The recording unit may analyze the content of a user's conversation and customize the recording method of the conversation based on the user's hobbies and interests. For example, if the user is interested in sports, conversations related to sports are preferentially recorded. If the user is interested in music, conversations related to music may be preferentially recorded. Furthermore, if the user is interested in travel, conversations related to travel may be preferentially recorded. In this way, the recording method of conversations can be customized based on the user's hobbies and interests, and important conversations for the user can be preferentially recorded. Specifically, the recording unit refers to a user profile database (e.g., hobbies=sports, music, travel) and past conversation history to generate keyword lists and topic classification models for each area of interest. The recording unit inputs real-time conversation text (e.g., about 100 tokens per utterance) into a large language model for natural language processing, and calculates topic classification (e.g., sports, music, travel, etc.) and interest scores (0.0 to 1.0) for each utterance. Examples of input to the AI include “utterance text+hobby list” and “utterance text+past hobby-related conversations.” Examples of AI output include “utterance topic: sports, interest score 0.9” and “utterance topic: music, interest score 0.8.” The recording unit preferentially records utterances with interest scores above a predetermined threshold (e.g., 0.7), and reduces the recording frequency or excludes other utterances from recording. As a subsequent process, the recording unit notifies the analysis unit of recorded data for each area of interest, which is used as basic data for individually optimized topic generation and feedback. As a technical effect, the recording unit realizes real-time filtering and recording optimization for hobbies and interests, which are difficult to achieve by human subjective judgment or manual work, thereby improving the relevance of recorded data, reducing unnecessary data, and enhancing user experience. Application fields include conversation monitoring for elderly people at home, individualized care support in nursing facilities, remote medical monitoring, and personal health management applications.

The analysis unit may estimate a user's emotion and adjust the method of presenting analysis results based on the estimated emotion. For example, when the user is relaxed, detailed analysis results are provided. When the user is feeling stressed, concise analysis results may be provided. Furthermore, when the user is excited, visually easy-to-understand analysis results may be provided. In this way, appropriate analysis results can be provided according to the user's emotion, allowing the user to receive information in an easily understandable form. Specifically, the analysis unit inputs utterance text data received from the recording unit (e.g., 1 day's conversation, 1000 tokens; text sequence of the latest 10 utterances), audio features (e.g., MFCC, pitch, spectrogram), facial images (224×224 pixels), etc. into a multimodal emotion estimation model (Transformer+CNN/RNN hybrid), and estimates emotion labels (relaxation, excitement, stress) and emotion scores (e.g., relaxation 0.7, excitement 0.2, stress 0.1). Examples of input to the AI include “utterance text+audio spectrogram” and “conversation history+facial image.” The analysis unit receives outputs such as “emotion label: relaxation” and “emotion score: relaxation 0.7” from the AI, and dynamically adjusts the method of presenting analysis results (level of detail, degree of summarization, visualization format, etc.) according to the emotion label and score. For example, during relaxation, a detailed analysis report (e.g., importance score for each utterance, keyword list, time-series graph, etc.) is generated; during stress, a concise summary extracting only the main points is generated; and during excitement, analysis results emphasizing visual elements such as graphs and icons are generated. As a subsequent process, the analysis unit transmits the generated analysis results to the providing unit, thereby realizing information presentation tailored to the user's psychological state. As a technical effect, the analysis unit realizes real-time emotion estimation and automatic optimization of analysis result presentation methods, which are difficult to achieve by human subjective judgment or manual work, thereby improving user comprehension, reducing stress, and enhancing user experience. Application fields include conversation analysis support for elderly people at home, psychological care in nursing facilities, remote medical monitoring, and personal health management applications.

The recording unit may analyze the content of a user's conversation and adjust the timing for recording a conversation based on the user's daily rhythm. For example, if the user has a morning-oriented lifestyle, the recording frequency for conversations is set higher in the morning hours. If the user has a night-oriented lifestyle, the recording frequency for conversations may be set higher in the evening hours. Furthermore, if the user has an irregular lifestyle, the timing for recording conversations may be adjusted according to the user's daily rhythm. In this way, the timing for recording conversations can be adjusted based on the user's daily rhythm, ensuring that important conversations are not missed. Specifically, the recording unit obtains user activity history data (e.g., activity logs from a smartwatch, calendar schedules, sleep records, etc.) and past conversation recording times from a database, and inputs them into a time-series analysis model (e.g., LSTM-based time-series prediction model). The recording unit automatically determines daily rhythm patterns (e.g., morning-oriented, night-oriented, irregular), and generates an optimal recording timing schedule (e.g., 7:00-9:00 a.m., 20:00-22:00 p.m., etc.). Examples of input to the AI include “activity logs for the past week+conversation recording times” and “sleep records+utterance times.” Examples of AI output include “recommended recording timing: 7:00-8:00 a.m.” and “recommended recording timing: 21:00-22:00 p.m.” The recording unit dynamically adjusts the recording frequency of real-time conversation data based on the recommended timing, preventing the omission of important conversations. As a subsequent process, the recording unit notifies the analysis unit and providing unit of recording timing information, thereby coordinating the overall system behavior. As a technical effect, the recording unit realizes daily rhythm analysis and optimization of recording timing, which are difficult to achieve by human subjective judgment or manual work, thereby improving the comprehensiveness of recorded data, reducing unnecessary data, and enhancing user experience. Application fields include conversation monitoring for elderly people at home, efficiency improvement of recording operations in nursing facilities, remote medical support, and personal health management applications.

The providing unit may estimate a user's emotion and adjust the format of information to be provided based on the estimated emotion. For example, when the user is relaxed, information is provided in text format. When the user is feeling stressed, information may be provided in audio format. Furthermore, when the user is excited, information may be provided in a visually easy-to-understand graphic format. In this way, information can be provided in an appropriate format according to the user's emotion, making it easier for the user to receive information. Specifically, the providing unit inputs utterance text, audio features, facial images, etc. received from the recording unit and analysis unit into a multimodal emotion estimation model (Transformer+CNN/RNN hybrid), and estimates emotion labels (relaxation, excitement, stress) and emotion scores (e.g., relaxation 0.7, excitement 0.2, stress 0.1). Examples of input to the AI include “utterance text+audio spectrogram” and “conversation history+facial image.” The providing unit receives outputs such as “emotion label: relaxation” and “emotion score: relaxation 0.7” from the AI, and dynamically adjusts the format of the information to be provided (text, audio, graphic, etc.) according to the emotion label and score. For example, during relaxation, information is generated and provided in text format; during stress, information is generated and provided in audio format by speech synthesis; and during excitement, information is generated and provided in graphic format emphasizing visual elements such as graphs and icons. As a subsequent process, the providing unit outputs the generated information in the optimal format to the user interface, thereby realizing information presentation tailored to the user's psychological state. As a technical effect, the providing unit realizes real-time emotion estimation and automatic optimization of information format, which are difficult to achieve by human subjective judgment or manual work, thereby improving user comprehension, reducing stress, and enhancing user experience. Application fields include conversation analysis support for elderly people at home, psychological care in nursing facilities, remote medical monitoring, and personal health management applications.

The recording unit may analyze the content of a user's conversation and adjust the recording method of the conversation based on the user's social relationships. For example, if the user places importance on conversations with family, conversations with family are preferentially recorded. If the user places importance on conversations with friends, conversations with friends may be preferentially recorded. Furthermore, if the user places importance on conversations at the workplace, conversations at the workplace may be preferentially recorded. In this way, the recording method of conversations can be adjusted based on the user's social relationships, and important conversations for the user can be preferentially recorded. Specifically, the recording unit refers to a user profile database (e.g., family structure, friend list, workplace information) and past conversation history to generate keyword lists and topic classification models for each relationship. The recording unit inputs real-time conversation text (e.g., about 100 tokens per utterance) into a large language model for natural language processing, and calculates relationship classification (e.g., family, friend, workplace, etc.) and interest scores (0.0 to 1.0) for each utterance. Examples of input to the AI include “utterance text+family list” and “utterance text+workplace information.” Examples of AI output include “utterance relationship: family, interest score 0.9” and “utterance relationship: friend, interest score 0.8.” The recording unit preferentially records utterances with interest scores above a predetermined threshold (e.g., 0.7), and reduces the recording frequency or excludes other utterances from recording. As a subsequent process, the recording unit notifies the analysis unit of recorded data for each relationship, which is used as basic data for individually optimized topic generation and feedback. As a technical effect, the recording unit realizes real-time filtering and recording optimization for relationships, which are difficult to achieve by human subjective judgment or manual work, thereby improving the relevance of recorded data, reducing unnecessary data, and enhancing user experience. Application fields include conversation monitoring for elderly people at home, individualized care support in nursing facilities, remote medical monitoring, and personal health management applications.

The providing unit may estimate a user's emotion and adjust the frequency of information provision based on the estimated emotion. For example, when the user is relaxed, the frequency of information provision is set low. When the user is feeling stressed, the frequency of information provision may be set high. Furthermore, when the user is excited, the frequency of information provision may be set to a medium level. In this way, information can be provided at an appropriate frequency according to the user's emotion, making it easier for the user to receive information. Specifically, the providing unit inputs utterance text, audio features, facial images, etc. received from the recording unit and analysis unit into a multimodal emotion estimation model (Transformer+CNN/RNN hybrid), and estimates emotion labels (relaxation, excitement, stress) and emotion scores (e.g., relaxation 0.7, excitement 0.2, stress 0.1). Examples of input to the AI include “utterance text+audio spectrogram” and “conversation history+facial image.” The providing unit receives outputs such as “emotion label: relaxation” and “emotion score: relaxation 0.7” from the AI, and dynamically adjusts information provision frequency parameters (e.g., once per day, every hour, every 30 minutes, etc.) according to the emotion label and score. For example, during relaxation, information is provided once per day; during stress, information is provided every 30 minutes; and during excitement, information is provided every hour. As a subsequent process, the providing unit notifies the user interface of the information provision frequency parameters, thereby realizing information presentation tailored to the user's psychological state. As a technical effect, the providing unit realizes real-time emotion estimation and automatic optimization of information provision frequency, which are difficult to achieve by human subjective judgment or manual work, thereby improving user comprehension, reducing stress, and enhancing user experience. Application fields include conversation analysis support for elderly people at home, psychological care in nursing facilities, remote medical monitoring, and personal health management applications.

Below, the processing flow of Example of the Embodiment is briefly described. Specifically, the present system operates in cooperation among the recording unit, analysis unit, and providing unit modules to process user conversation data with high accuracy and in real time. The recording unit acquires the user's utterance audio using a high-precision microphone array and records it as 16 kHz/16 bit PCM audio data. The recording unit converts the audio data into a spectrogram and extracts acoustic features such as MFCC, zero-crossing rate, and pitch. These features are input into a deep neural network-based speech recognition model (e.g., encoder-decoder type RNN or Transformer-based model), which outputs utterance text and confidence scores. The analysis unit inputs the text data obtained from the recording unit into a large language model for natural language processing (e.g., Transformer-based encoder-decoder model) and performs word embedding, importance scoring, keyword extraction, topic classification, and self-contradiction detection. Examples of input to the AI include one day's conversation text (1000 tokens), a sequence of the latest 10 utterances, etc., and examples of output include a list of important utterances (utterance text+utterance time+importance score), keyword extraction results, and self-contradiction detection flags. The providing unit receives the output from the analysis unit and displays the analysis results on a user interface (tablet terminal, smart speaker, etc.) or outputs them via speech synthesis. For example, the system may display “There was a similar statement in the past” on the screen or notify “You talked about the same topic last week” via audio. Furthermore, the providing unit refers to the user profile database and inputs related topic sentences as prompts to a topic generation AI, giving instructions such as “Generate three old stories about the user's place of origin.” Example outputs include topic sentences such as “Do you have memories of snowball fights in winter when you were a child?” These topics are designed to promote memory recall and activate the brain. The system periodically aggregates analysis results and generates cognitive function scores (time-series graphs of memory, attention, utterance volume, etc.), which are fed back to the user, family, and medical professionals. As a technical effect, the present system realizes high-speed processing of large-scale data, self-contradiction detection in utterance content, individually optimized topic generation, and quantitative cognitive function evaluation, which are impossible with manual recording, analysis, and topic provision by humans. This enables high-accuracy and real-time detection of early signs of dementia and optimal preventive intervention for each user. Application fields include monitoring of elderly people at home, dementia prevention programs in nursing facilities, remote medical support, and personal health management applications.

Step 1: The recording unit records the user's daily conversations. The recording unit uses speech recognition technology to convert conversations into text data in real time and records them. For example, the recording unit collects the content spoken by the user via a microphone and converts it into text data using speech recognition technology. The recording unit may also record the content spoken by the user and later convert it into text data using speech recognition technology. Step 2: The analysis unit analyzes the conversations recorded by the recording unit. The analysis unit uses AI to analyze the content of the conversation and extracts important content and specific keywords. The AI analyzes the content of the conversation using natural language processing technology and extracts important information. For example, the analysis unit extracts frequently occurring keywords or specific topics in the conversation. The analysis unit may also analyze the content of the conversation based on keywords set by the user. Step 3: The providing unit provides the analysis result obtained by the analysis unit to the user. The providing unit provides the analysis result to the user using screen display or audio output. For example, the providing unit displays the analysis result on the screen so that the user can check it. The providing unit may also output the analysis result via audio and provide it to the user. Specifically, the recording unit acquires the user's utterance audio using a high-precision microphone array and records it as 16 kHz/16 bit PCM audio data. The recording unit converts the audio data into a spectrogram and extracts acoustic features such as MFCC, zero-crossing rate, and pitch. These features are input into a deep neural network-based speech recognition model (e.g., encoder-decoder type RNN or Transformer-based model), which outputs utterance text and confidence scores. The analysis unit inputs the text data obtained from the recording unit into a large language model for natural language processing (e.g., Transformer-based encoder-decoder model) and performs word embedding, importance scoring, keyword extraction, topic classification, and self-contradiction detection. Examples of input to the AI include one day's conversation text (1000 tokens), a sequence of the latest 10 utterances, etc., and examples of output include a list of important utterances (utterance text+utterance time+importance score), keyword extraction results, and self-contradiction detection flags. The providing unit receives the output from the analysis unit and displays the analysis results on a user interface (tablet terminal, smart speaker, etc.) or outputs them via speech synthesis. For example, the system may display “There was a similar statement in the past” on the screen or notify “You talked about the same topic last week” via audio. Furthermore, the providing unit refers to the user profile database and inputs related topic sentences as prompts to a topic generation AI, giving instructions such as “Generate three old stories about the user's place of origin.” Example outputs include topic sentences such as “Do you have memories of snowball fights in winter when you were a child?” These topics are designed to promote memory recall and activate the brain. The system periodically aggregates analysis results and generates cognitive function scores (time-series graphs of memory, attention, utterance volume, etc.), which are fed back to the user, family, and medical professionals. As a technical effect, the present system realizes high-speed processing of large-scale data, self-contradiction detection in utterance content, individually optimized topic generation, and quantitative cognitive function evaluation, which are impossible with manual recording, analysis, and topic provision by humans. This enables high-accuracy and real-time detection of early signs of dementia and optimal preventive intervention for each user. Application fields include monitoring of elderly people at home, dementia prevention programs in nursing facilities, remote medical support, and personal health management applications.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL: https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of the plurality of elements including the aforementioned recording unit, analysis unit, and providing unit is implemented by at least one of, for example, the smart device 14 and the data processing apparatus 12. For example, the recording unit collects a user's daily conversations using a microphone 38B of the smart device 14 and converts them into text data using speech recognition technology. The analysis unit is implemented, for example, by a specific processing unit 290 of the data processing apparatus 12, analyzes the content of the conversation using AI, and extracts important content and specific keywords. The providing unit provides the analysis result to the user using, for example, a display 40A or a speaker 40B of the smart device 14. The correspondence between each unit and the device or control unit is not limited to the examples described above and various modifications are possible.

### Second Embodiment

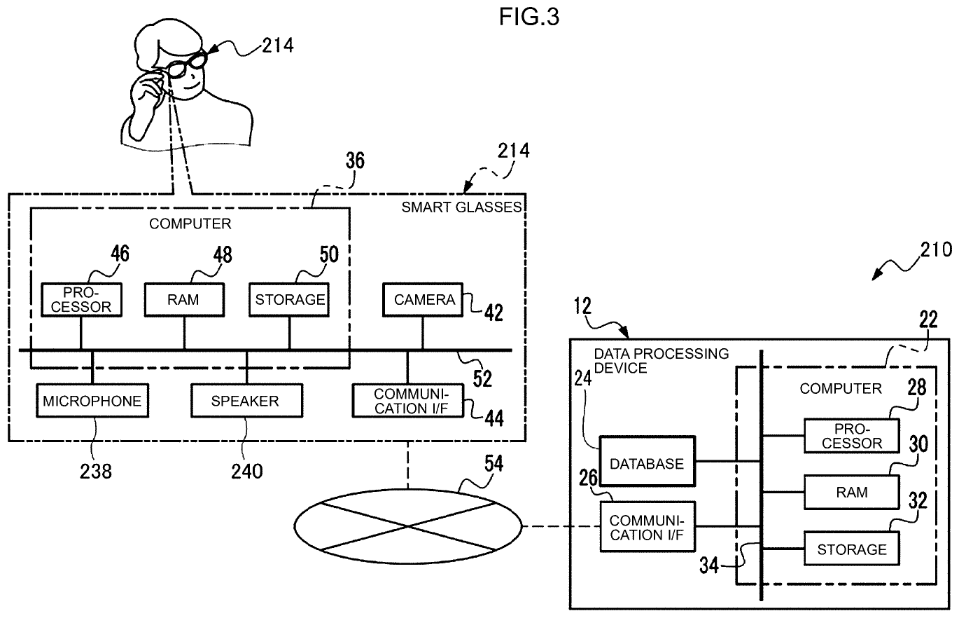

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

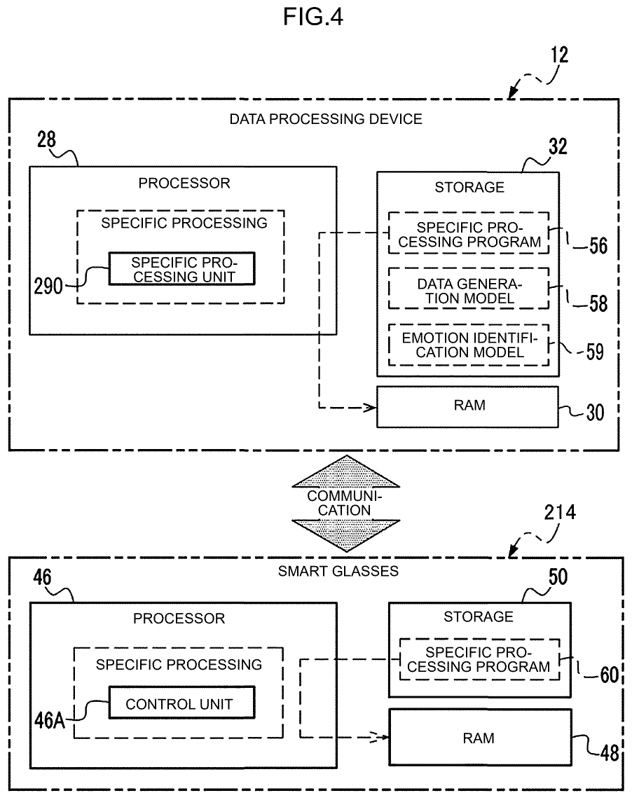

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of the plurality of elements including the aforementioned recording unit, analysis unit, and providing unit is implemented by at least one of, for example, the smart glasses 214 and the data processing apparatus 12. For example, the recording unit collects a user's daily conversations using a microphone 238 of the smart glasses 214 and converts them into text data using speech recognition technology. The analysis unit is implemented, for example, by a specific processing unit 290 of the data processing apparatus 12, analyzes the content of the conversation using AI, and extracts important content and specific keywords. The providing unit provides the analysis result to the user using, for example, a speaker 240 of the smart glasses 214. The correspondence between each unit and the device or control unit is not limited to the examples described above and various modifications are possible.

### Third Embodiment

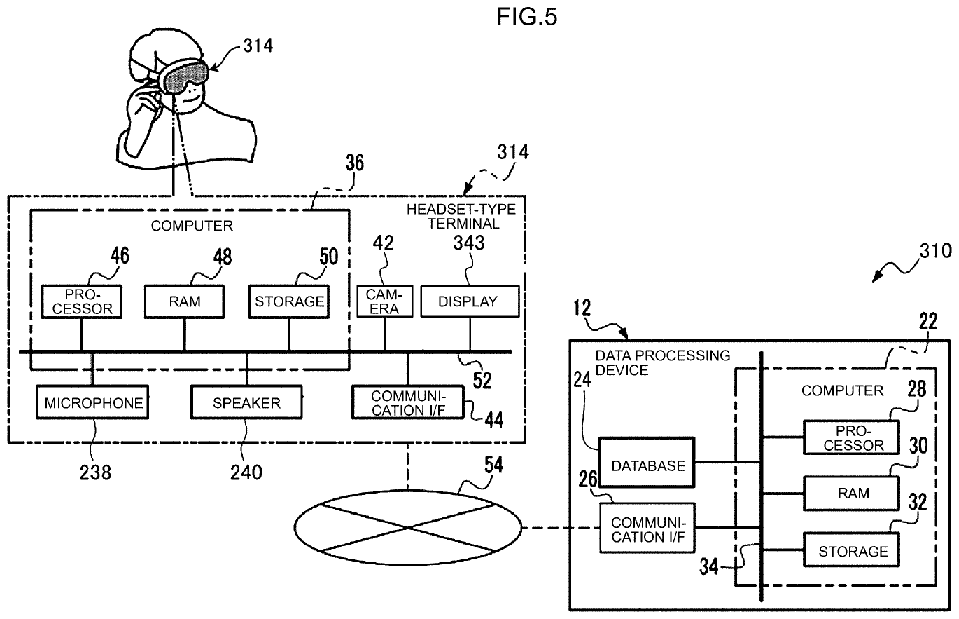

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

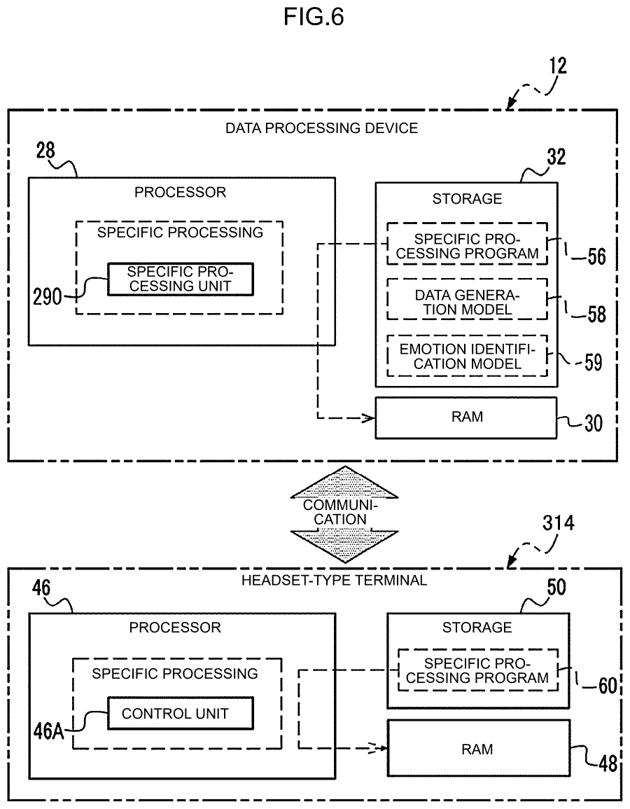

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of the plurality of elements including the aforementioned recording unit, analysis unit, and providing unit is implemented by at least one of, for example, the headset-type terminal 314 and the data processing apparatus 12. For example, the recording unit collects a user's daily conversations using a microphone 238 of the headset-type terminal 314 and converts them into text data using speech recognition technology. The analysis unit is implemented, for example, by a specific processing unit 290 of the data processing apparatus 12, analyzes the content of the conversation using AI, and extracts important content and specific keywords. The providing unit provides the analysis result to the user using, for example, a speaker 240 of the headset-type terminal 314. The correspondence between each unit and the device or control unit is not limited to the examples described above and various modifications are possible.

### Fourth Embodiment

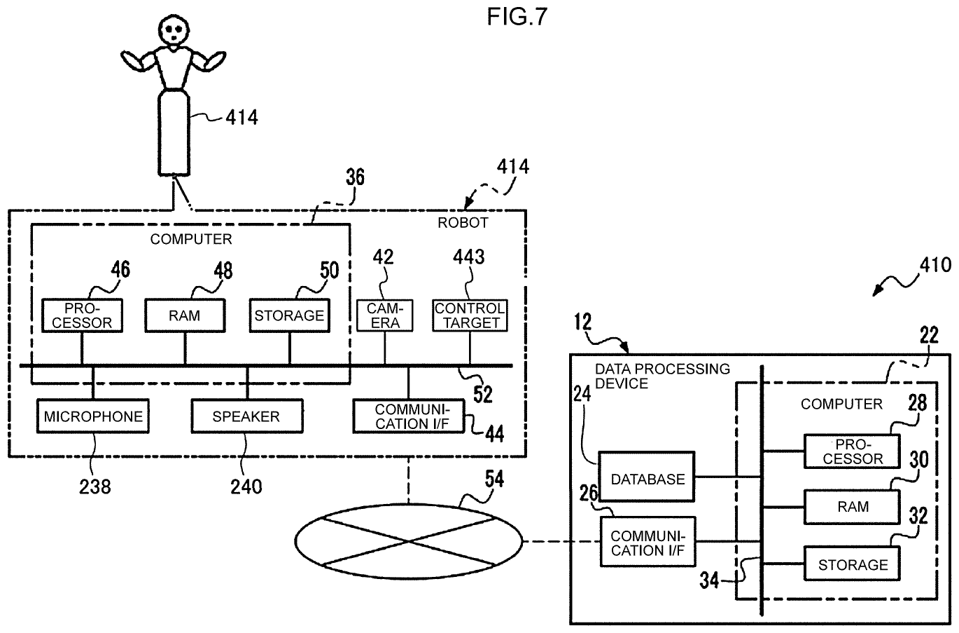

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

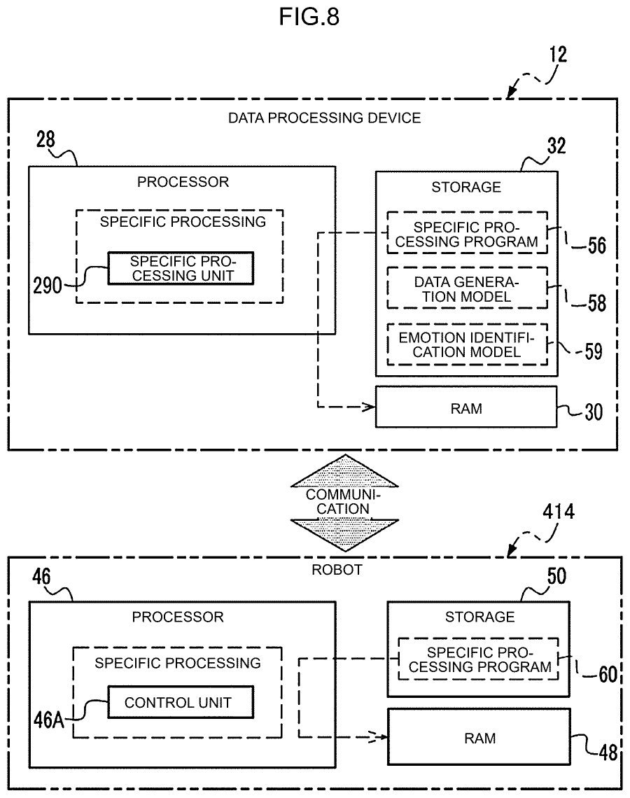

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of the plurality of elements including the aforementioned recording unit, analysis unit, and providing unit is implemented by at least one of, for example, the robot 414 and the data processing apparatus 12. For example, the recording unit collects a user's daily conversations using a microphone 238 of the robot 414 and converts them into text data using speech recognition technology. The analysis unit is implemented, for example, by a specific processing unit 290 of the data processing apparatus 12, analyzes the content of the conversation using AI, and extracts important content and specific keywords. The providing unit provides the analysis result to the user using, for example, a speaker 240 of the robot 414. The correspondence between each unit and the device or control unit is not limited to the examples described above and various modifications are possible.

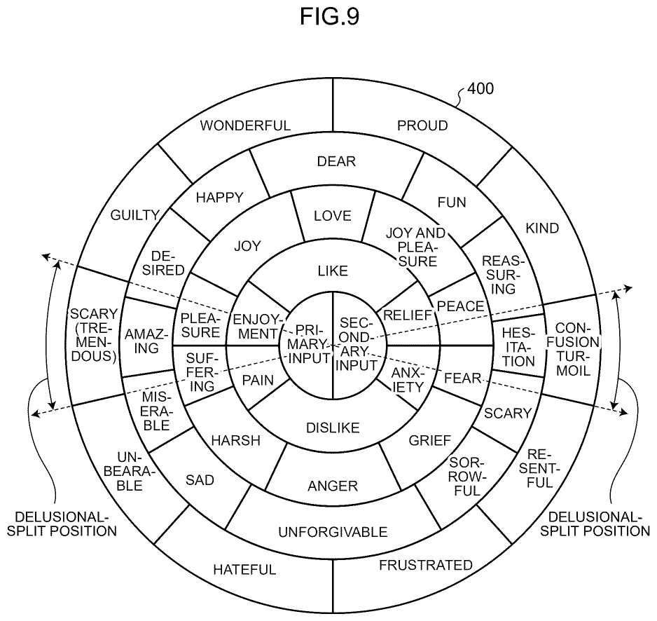

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

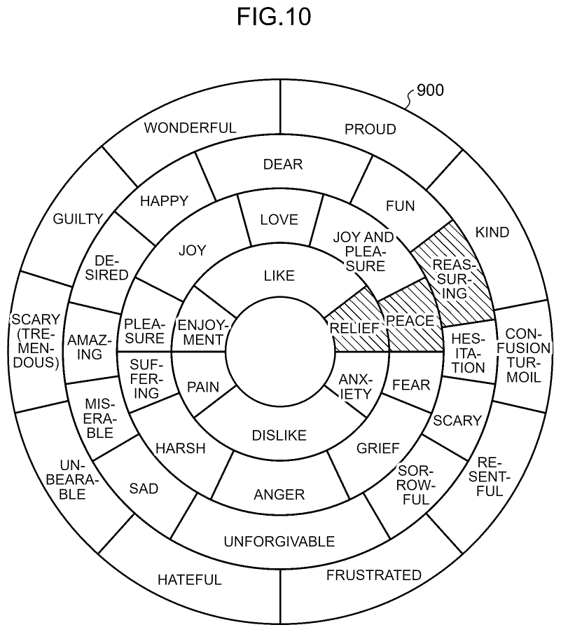

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

(Supplementary Note 1) A system comprising: a recording unit configured to record conversations; an analysis unit configured to analyze conversations recorded by the recording unit; and a providing unit configured to provide a user with an analysis result obtained by the analysis unit.

(Supplementary Note 2) The system according to Supplementary Note 1, wherein the analysis unit is configured to extract important content and specific keywords.

(Supplementary Note 3) The system according to Supplementary Note 1, wherein the providing unit comprises a topic providing unit configured to provide topics related to the user's place of origin and past events.

(Supplementary Note 4) The system according to Supplementary Note 1, wherein the providing unit comprises a feedback unit configured to periodically provide feedback of the analysis result.

(Supplementary Note 5) The system according to Supplementary Note 1, wherein the recording unit is configured to estimate a user's emotion and adjust a timing for recording a conversation based on the estimated emotion of the user.

(Supplementary Note 6) The system according to Supplementary Note 1, wherein the recording unit is configured to analyze a user's past conversation history and select an appropriate recording method.

(Supplementary Note 7) The system according to Supplementary Note 1, wherein the recording unit is configured to perform filtering based on the user's current living situation and areas of interest when recording a conversation.

(Supplementary Note 8) The system according to Supplementary Note 1, wherein the recording unit is configured to estimate a user's emotion and determine a priority of conversations to be recorded based on the estimated emotion of the user.

(Supplementary Note 9) The system according to Supplementary Note 1, wherein the recording unit is configured to preferentially record highly relevant conversations by considering the user's geographic location information when recording a conversation.

(Supplementary Note 10) The system according to Supplementary Note 1, wherein the recording unit is configured to analyze a user's social media activity and record relevant conversations when recording a conversation.

(Supplementary Note 11) The system according to Supplementary Note 1, wherein the analysis unit is configured to estimate a user's emotion and adjust a method of expressing analysis based on the estimated emotion of the user.

(Supplementary Note 12) The system according to Supplementary Note 1, wherein the analysis unit is configured to adjust a level of detail of analysis based on the importance of the conversation during analysis.

(Supplementary Note 13) The system according to Supplementary Note 1, wherein the analysis unit is configured to apply different analysis algorithms according to a category of the conversation during analysis.

(Supplementary Note 14) The system according to Supplementary Note 1, wherein the analysis unit is configured to estimate a user's emotion and adjust a length of analysis based on the estimated emotion of the user.

(Supplementary Note 15) The system according to Supplementary Note 1, wherein the analysis unit is configured to determine a priority of analysis based on a time of utterance of the conversation during analysis.

(Supplementary Note 16) The system according to Supplementary Note 1, wherein the analysis unit is configured to adjust an order of analysis based on a relevance of the conversation during analysis.

(Supplementary Note 17) The system according to Supplementary Note 1, wherein the providing unit is configured to estimate a user's emotion and adjust a method of expressing provision based on the estimated emotion of the user.

(Supplementary Note 18) The system according to Supplementary Note 1, wherein the providing unit is configured to adjust a level of detail of provision based on an importance of the analysis result during provision.

(Supplementary Note 19) The system according to Supplementary Note 1, wherein the providing unit is configured to apply different provision algorithms according to a category of the analysis result during provision.

(Supplementary Note 20) The system according to Supplementary Note 1, wherein the providing unit is configured to estimate a user's emotion and adjust a length of provision based on the estimated emotion of the user.

(Supplementary Note 21) The system according to Supplementary Note 1, wherein the providing unit is configured to determine a priority of provision based on a time of utterance of the analysis result during provision.

(Supplementary Note 22) The system according to Supplementary Note 1, wherein the providing unit is configured to adjust an order of provision based on a relevance of the analysis result during provision.

(Supplementary Note 23) The system according to Supplementary Note 2, wherein the topic providing unit is configured to estimate a user's emotion and adjust a method of providing topics based on the estimated emotion of the user.

(Supplementary Note 24) The system according to Supplementary Note 2, wherein the topic providing unit is configured to refer to a user's past conversation history and select appropriate topics when providing topics.

(Supplementary Note 25) The system according to Supplementary Note 2, wherein the topic providing unit is configured to customize a content of topics based on the user's current living situation when providing topics.

(Supplementary Note 26) The system according to Supplementary Note 2, wherein the topic providing unit is configured to estimate a user's emotion and determine a priority of topics based on the estimated emotion of the user.

(Supplementary Note 27) The system according to Supplementary Note 2, wherein the topic providing unit is configured to consider the user's geographic location information and select appropriate topics when providing topics.

(Supplementary Note 28) The system according to Supplementary Note 2, wherein the topic providing unit is configured to analyze a user's social media activity and provide relevant topics when providing topics.

(Supplementary Note 29) The system according to Supplementary Note 3, wherein the feedback unit is configured to estimate a user's emotion and adjust a method of feedback based on the estimated emotion of the user.

(Supplementary Note 30) The system according to Supplementary Note 3, wherein the feedback unit is configured to refer to a user's past conversation history and provide optimal feedback when providing feedback.

(Supplementary Note 31) The system according to Supplementary Note 3, wherein the feedback unit is configured to customize a content of feedback based on the user's current living situation when providing feedback.

(Supplementary Note 32) The system according to Supplementary Note 3, wherein the feedback unit is configured to estimate a user's emotion and determine a priority of feedback based on the estimated emotion of the user.

(Supplementary Note 33) The system according to Supplementary Note 3, wherein the feedback unit is configured to consider the user's geographic location information and provide appropriate feedback when providing feedback.

(Supplementary Note 34) The system according to Supplementary Note 3, wherein the feedback unit is configured to analyze a user's social media activity and propose a content of feedback when providing feedback.

What is claimed is:

1. A system comprising:
circuitry configured to:
receive, via a communication interface coupled to a packet-switched network, audio waveform data captured by a microphone of a client terminal;
convert the audio waveform data into text data by inputting the audio waveform data into a speech recognition model comprising a Transformer-based neural network stored in a memory;
generate, by inputting the text data into a data generation model comprising a large language model obtained by deep learning on a neural network, inference data comprising at least one of an importance score for each utterance in the text data, a keyword list extracted by attention weight computation, or a contradiction detection flag;
generate, by inputting attribute data and the keyword list into the data generation model, topic data comprising a natural-language sentence related to at least one attribute indicated by the attribute data; and
transmit the inference data and the topic data to the client terminal via the communication interface and the packet-switched network.

2. The system according to claim 1, wherein the inference data further comprises a cognitive function score computed from the text data over a predetermined time period, the cognitive function score comprising at least one of a memory score, an attention score, or an utterance volume score represented as time-series data.

3. The system according to claim 1, wherein the circuitry is further configured to estimate an emotion of a user by inputting the audio waveform data into an emotion identification model comprising a multimodal neural network integrating a convolutional neural network and a recurrent neural network, the emotion identification model outputting an emotion label as a probability distribution over a plurality of emotion categories.

4. The system according to claim 3, wherein the plurality of emotion categories comprises at least relaxed, excited, and stressed, and wherein the circuitry is further configured to adjust a level of detail of the inference data based on the emotion label having a highest probability value among the plurality of emotion categories.

5. The system according to claim 3, wherein the circuitry is further configured to adjust a timing for receiving the audio waveform data based on the emotion label, the timing being set to a lower frequency when the emotion label indicates relaxed and to a higher frequency when the emotion label indicates excited.

6. The system according to claim 3, wherein the circuitry is further configured to determine a priority score for each utterance in the text data based on the emotion label and to preferentially process utterances having a priority score above a predetermined threshold.

7. The system according to claim 1, wherein the circuitry is further configured to extract, from the text data, a topic distribution by latent Dirichlet allocation and a frequent keyword list ranked by term frequency-inverse document frequency score.

8. The system according to claim 1, wherein the attribute data comprises at least one of a geographic origin, a hobby, or a past event associated with a user, and wherein the topic data comprises a sentence configured to prompt recall of a memory associated with the at least one attribute.

9. The system according to claim 1, wherein the circuitry is further configured to retrieve, from a database, a conversation history comprising text data accumulated over a preceding time period, and to compute a similarity score between the text data and the conversation history by cosine similarity of word embedding vectors.

10. The system according to claim 9, wherein the contradiction detection flag is set when a current utterance in the text data contradicts a prior utterance in the conversation history, the contradiction being determined by the data generation model comparing semantic representations of the current utterance and the prior utterance.

11. The system according to claim 1, wherein the circuitry is further configured to receive geographic location data from the client terminal and to compute a relevance score between each utterance in the text data and the geographic location data, the circuitry preferentially processing utterances having a relevance score above a predetermined threshold.

12. The system according to claim 1, wherein the circuitry is further configured to periodically aggregate the inference data over a predetermined schedule and to generate a feedback report comprising at least one of a time-series graph of the importance scores or a summary sentence generated by the data generation model.

13. The system according to claim 1, wherein the circuitry is further configured to classify each utterance in the text data into one of a plurality of categories comprising at least a home category, a business category, and an emotional category, and to apply a different analysis algorithm of the data generation model to each category.

14. The system according to claim 1, wherein the circuitry is further configured to filter the audio waveform data based on a user profile comprising a current living situation and at least one area of interest, the circuitry preferentially converting audio waveform data corresponding to the at least one area of interest.

15. The system according to claim 1, wherein the speech recognition model converts the audio waveform data into a spectrogram comprising mel-frequency cepstral coefficients as a multidimensional tensor, and generates the text data with a confidence score for each utterance.

16. The system according to claim 1, wherein the circuitry is further configured to generate the topic data by referencing a conversation history of a preceding time period and extracting, by the data generation model, a topic clustering result and a time-series pattern from the conversation history.

17. The system according to claim 1, wherein the circuitry is further configured to adjust an order of transmitting the inference data based on a relevance of each utterance to at least one area of interest indicated by a user profile, the circuitry preferentially transmitting inference data corresponding to utterances having a higher relevance.

18. A system comprising:
circuitry configured to:
receive, via a communication interface coupled to a packet-switched network comprising at least one of a wide area network or a local area network, audio waveform data sampled at 16 kHz as a one-dimensional array from a microphone of a client terminal;
convert the audio waveform data into a spectrogram comprising mel-frequency cepstral coefficients of 128 dimensions, extract acoustic features comprising at least pitch and zero-crossing rate from the spectrogram, and input the acoustic features into a speech recognition model comprising a Transformer-based encoder-decoder neural network with a self-attention mechanism to generate text data with a confidence score for each utterance;
generate word embedding vectors by inputting the text data into a large language model obtained by deep learning on a neural network, and compute an importance score for each utterance by a self-attention mechanism of the large language model, a keyword list by term frequency-inverse document frequency weighting, and a contradiction detection flag by comparing a semantic representation of a current utterance with a semantic representation of a prior utterance retrieved from a database;
estimate an emotion of a user by inputting the acoustic features and the text data into an emotion identification model comprising a Transformer-based multimodal neural network integrating a convolutional neural network and a recurrent neural network, the emotion identification model outputting an emotion label and an emotion score as a probability distribution over a plurality of emotion categories comprising at least relaxed, excited, and stressed;
generate, by inputting attribute data, the keyword list, and a conversation history into the large language model, topic data comprising a natural-language sentence related to at least one attribute indicated by the attribute data, the topic data being optimized based on the emotion label; and
transmit the importance score, the keyword list, the contradiction detection flag, the emotion label, and the topic data to the client terminal via the communication interface and the packet-switched network.

19. The system according to claim 18, wherein the circuitry is further configured to periodically aggregate the importance scores and the emotion scores over a predetermined schedule, generate a time-series graph of the importance scores and a summary report by the large language model, and transmit the time-series graph and the summary report to the client terminal.

20. A method performed by circuitry of a system, the method comprising:
receiving, via a communication interface coupled to a packet-switched network, audio waveform data captured by a microphone of a client terminal;
converting the audio waveform data into text data by inputting the audio waveform data into a speech recognition model comprising a Transformer-based neural network stored in a memory;
generating, by inputting the text data into a data generation model comprising a large language model obtained by deep learning on a neural network, inference data comprising at least one of an importance score for each utterance in the text data, a keyword list extracted by attention weight computation, or a contradiction detection flag;
generating, by inputting attribute data and the keyword list into the data generation model, topic data comprising a natural-language sentence related to at least one attribute indicated by the attribute data; and
transmitting the inference data and the topic data to the client terminal via the communication interface and the packet-switched network.
